(19) United States
(12) Patent Application Publication
(10) Pub. No.: US 2021/0039394 A1
(43) Pub. Date: Feb. 11, 2021

(54) INK ABSORBING MATERIAL, INK ABSORBING DEVICE, AND DROPLET EJECTING APPARATUS

(71) Applicant: SEIKO EPSON CORPORATION, Tokyo (JP)

(72) Inventor: Yoichi MIYASAKA, Suwa, Nagano (JP)

(21) Appl. No.: 17/041,499

(22) PCT Filed: Dec. 27, 2018
(86) PCT No.: PCT/JP2018/048022

§ 371 Date: Sep. 25, 2020

(30) Foreign Application Priority Data
Mar. 27, 2018 (JP) 2018-059708
Mar. 29, 2018 (JP) 2018-066260

(51) Int. Cl. B41J 2/165

(52) U.S. Cl. CPC B41J 2/16517

(57) ABSTRACT

The ink absorbing material is a chip aggregate that includes multiple chips each having a fiber-containing fibrous support and an absorbent polymer held by the fibrous support. In the ink absorbing material, each of the chips forming the chip aggregate preferably has the absorbent polymer on at least one side of the fibrous support, with the absorbent polymer adhering to the fibrous support.

### CROSS-REFERENCE TO RELATED APPLICATIONS

This application is a U.S. National stage application of International Patent Application No. PCT/JP2018/048022, filed on Dec. 27, 2018, which claims priority to Japanese Patent Application No. 2018-059708, filed in Japan on Mar. 27, 2018, and Japanese Patent Application No. 2018-066260, filed in Japan on Mar. 29, 2018. The entire disclosures of Japanese Patent Application Nos. 2018-059708 and 2018-066260 are hereby incorporated herein by reference.

### TECHNICAL FIELD

The present invention relates to an ink absorbing material, an ink absorbing device, and a droplet ejecting apparatus.

### BACKGROUND ART

Ink jet printers usually produce waste ink during a head cleaning operation, which is performed to prevent low print quality due to clogging with ink, and an ink loading operation after the replacement of ink cartridge(s). To prevent accidental adhesion of such waste ink, for example to internal mechanisms, ink jet printers are equipped with a liquid absorber that absorbs waste ink (ink absorber).

In the related art, the liquid absorber (ink absorber) has been one that contains natural cellulose fiber and/or a synthetic fiber and a heat-fusible substance (e.g., see Japanese Patent No. 3536870).

Alternatively, the liquid absorber has been one that contains a hydrophilic fiber and a highly absorbent polymer (e.g., see Japanese Unexamined Patent Application Publication No. 4-90851).

### SUMMARY

With the known liquid absorbers (ink absorbers), however, waste ink cannot be absorbed quickly because of their poor permeability to ink. The absorbed ink, moreover, can accidentally leak depending on the amount of ink absorbed.

The liquid absorber according to Japanese Unexamined Patent Application Publication No. 4-90851, furthermore, is shaped like a block as a whole. This liquid absorber is therefore not compliant with the shape of its container, making it difficult to adjust its amount and density in its container. Another disadvantage of the liquid absorber according to Japanese Unexamined Patent Application Publication No. 4-90851 is that the highly absorbent polymer can detach from the hydrophilic fiber, for example because of an external impact. This can cause uneven ink absorption properties as a result of separation between the hydrophilic fiber and the highly absorbent polymer in the container.

An object of the present invention is to provide an ink absorbing material that offers improved ink absorption properties and the prevention of leakages of absorbed ink, to provide an ink absorbing device, and to provide a droplet ejecting apparatus.

An object of the present invention, furthermore, is to provide an ink absorbing material the desired amount (appropriate amount) of which can be packed into a container with reduced occurrence of uneven ink absorption properties, to provide an ink absorbing device, and to provide a droplet ejecting apparatus.

The present invention was made to solve at least part of the above problem and can be implemented as follows.

An ink absorbing material according to the present invention is a chip aggregate that includes multiple chips each having a fiber-containing fibrous support and an absorbent polymer held by the fibrous support.

This ensures that when ink is supplied to the chip aggregate, the chance of contact with the ink and the area of contact with the ink are maximized. The fiber (fibrous support), furthermore, retains the ink temporarily. The ink can then be sent from the fiber to the absorbent polymer more efficiently, hence improved ink absorption properties of the chip aggregate as a whole. In addition, the chip aggregate provides long-term retention of absorbed ink; this helps prevent the ink from leaking.

In the ink absorbing material according to the present invention, each of the chips forming the chip aggregate preferably has the absorbent polymer on at least one side of the fibrous support, with the absorbent polymer adhering to the fibrous support.

This makes the absorbent polymer exposed on the fibrous support. With this absorbent polymer, therefore, ink can be absorbed quickly.

In the ink absorbing material according to the present invention, each of the chips forming the chip aggregate preferably has the absorbent polymer somewhere in a thickness dimension of the fibrous support.

This ensures that ink is retained (absorbed) as deep inside the sheets as it can be, or as close to the middle of the sheets in the direction of their thickness as it can be, hence extended retention of the ink.

In the ink absorbing material according to the present invention, each of the chips is preferably elongated one.

This makes the chips deform easily. When these chips (chip aggregate) are packed into a container, therefore, the chips deform whatever the internal shape of the container is, or displays shape compliance; as a result, the chip aggregate is packed all together smoothly.

In the ink absorbing material according to the present invention, there is preferably a connector that connects part of each of the elongated chips together.

This ensures that when the chip aggregate is packed into a container, multiple chips can be put into the container by holding the connector and casting it together with the connected chips; as a result, the packing work is easy and quick.

In the ink absorbing material according to the present invention, the absorbent polymer preferably contains a crosslinked polyacrylic-acid polymer.

This brings advantages such as improved performance on absorbing ink and the possibility of reduced production cost.

An ink absorbing device according to the present invention is an ink absorbing device that includes the ink absorbing material according to the present invention and a container in which the ink absorbing material is encased.

Each of the chips is elongated, and the ink absorbing material is encased in the container in such a manner that each of the chips extends in a direction that crosses a direction in which another extends inside the container.

This creates gaps between the chips. By virtue of this, ink can pass through the gaps and, when the gaps are microscopic, can spread by capillarity; that is, permeability to ink is guaranteed. The ink is therefore prevented from being interrupted, hence equal absorption and long-term retention by the chips.

An ink absorbing device according to the present invention is an ink absorbing device that includes the ink absorbing material according to the present invention and a container in which the ink absorbing material is encased.

Each of the chips is elongated, and the ink absorbing material is encased in the container in such a manner that each of the chips extends in the same direction inside the container.

This is effective, for example when ink flows down inside the chip aggregate and the user wants to reduce its downflow speed (penetration speed).

An ink absorbing device according to the present invention is an ink absorbing device that includes the ink absorbing material according to the present invention and a container in which the ink absorbing material is encased.

Each of the chips is elongated, and the ink absorbing material is encased in the container with the chips folded inside the container.

This ensures that when the chip aggregate is packed into the container, the chip aggregate can be packed into the container easily, although depending partly on the internal shape of the container. The chip aggregate, furthermore, then remains stably packed.

A droplet ejecting apparatus according to the present invention includes the ink absorbing device according to the present invention. The ink absorbing device is used to absorb waste ink.

This makes it possible to use an ink absorbing device as a so-called “waste liquid tank (waste ink tank)” of a droplet ejecting apparatus. After the amount of ink absorbed by the ink absorbing device reaches its limit, furthermore, this ink absorbing device can be replaced with a new (unused) ink absorbing device.

An ink absorbing material according to the present invention is a chip aggregate that includes multiple chips each having a fiber-containing fibrous support and an absorbent polymer at least part of which is spread inside the fibrous support.

An ink absorbing device according to the present invention includes the ink absorbing material according to the present invention and

a container into which the ink absorbing material is packed.

A droplet ejecting apparatus according to the present invention includes the above ink absorbing device. The ink absorbing device is used to absorb waste ink.

### BRIEF DESCRIPTION OF DRAWINGS

FIG. 1 is a partial vertical cross-sectional diagram illustrating an example of an ink absorbing device according to the present invention in use.

FIG. 2 is a perspective view of a chip as a member of the chip aggregate included in the ink absorbing device illustrated in FIG. 1.

FIG. 3 is a cross-sectional view along line A-A in FIG. 2.

FIG. 4 is an exploded perspective diagram illustrating the relative positions of chip aggregates to be packed in an ink absorbing device according to the present invention.

FIG. 5 is an exploded perspective diagram illustrating the relative positions of chip aggregates to be packed in an ink absorbing device according to the present invention.

FIG. 6 is a plan view of a chip aggregate to be packed in an ink absorbing device according to the present invention.

FIG. 7 is a plan diagram illustrating the chip aggregate of FIG. 6 in a container.

FIG. 8 is a cross-sectional view along line B-B in FIG. 7.

FIG. 9 is a cross-sectional view along line C-C in FIG. 7.

FIG. 10 is a vertical cross-sectional diagram illustrating a variation of chip aggregates packed in an ink absorbing device according to the present invention.

FIG. 11 is a perspective view of a chip as a member of a chip aggregate included in an ink absorbing device according to the present invention.

FIG. 12 is a perspective view of a chip as a member of a chip aggregate included in an ink absorbing device according to the present invention.

FIG. 13 is a vertical cross-sectional view of a chip as a member of a chip aggregate included in an ink absorbing device according to the present invention.

FIG. 14 is a perspective diagram illustrating an ink absorbing device according to the present invention.

FIG. 15 is a perspective diagram illustrating an exemplary form of an ink absorbing material according to the present invention.

FIG. 16 is a perspective diagram illustrating an exemplary form of an ink absorbing material according to the present invention.

FIG. 17 is a cross-sectional view of a chip included in an ink absorbing material according to the present invention.

FIG. 18 is a diagram illustrating a production process for the production of an ink absorbing material according to the present invention, illustrating the application of a water-soluble adhesive agent.

FIG. 19 is a diagram illustrating a production process for the production of an ink absorbing material according to the present invention, illustrating the supply of an absorbent polymer.

FIG. 20 is a diagram illustrating a production process for the production of an ink absorbing material according to the present invention, illustrating the heating and compression of a sheet-shaped fibrous support.

FIG. 21 is a cross-sectional view of a chip included in the ink absorbing device illustrated in FIG. 1.

FIG. 22 is a diagram illustrating a production process for the production of the ink absorbing material illustrated in FIG. 21, illustrating a sheet-shaped fibrous support folded with a water-soluble adhesive agent and an absorbent polymer supplied thereto.

FIG. 23 is a diagram illustrating a production process for the production of the ink absorbing material illustrated in FIG. 21, illustrating the heating and compression of a sheet-shaped fibrous support.

### DESCRIPTION OF EMBODIMENTS

The following describes the details of an ink absorbing material, an ink absorbing device, and a droplet ejecting apparatus according to the present invention based on their preferred embodiments illustrated in attached drawings.

### Embodiment 1

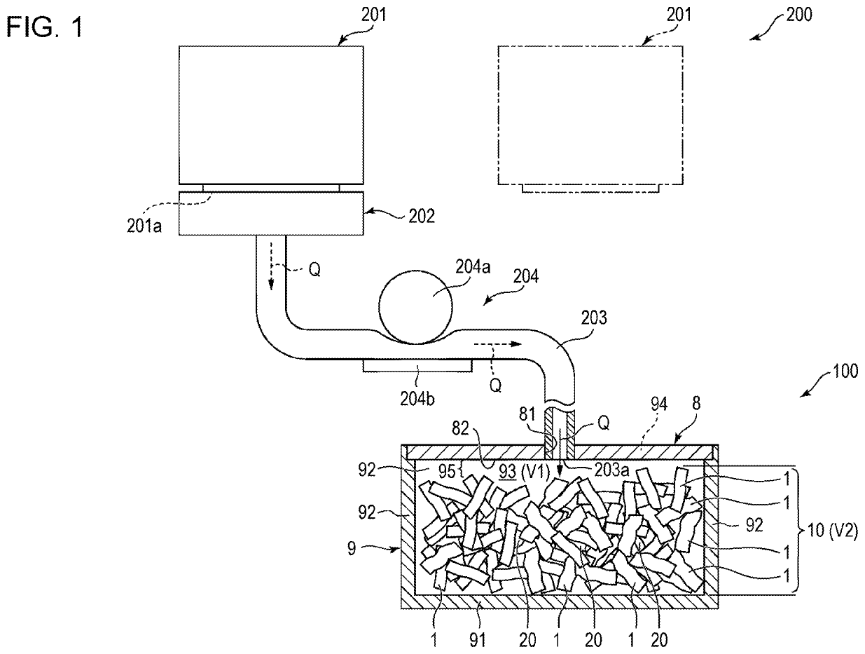

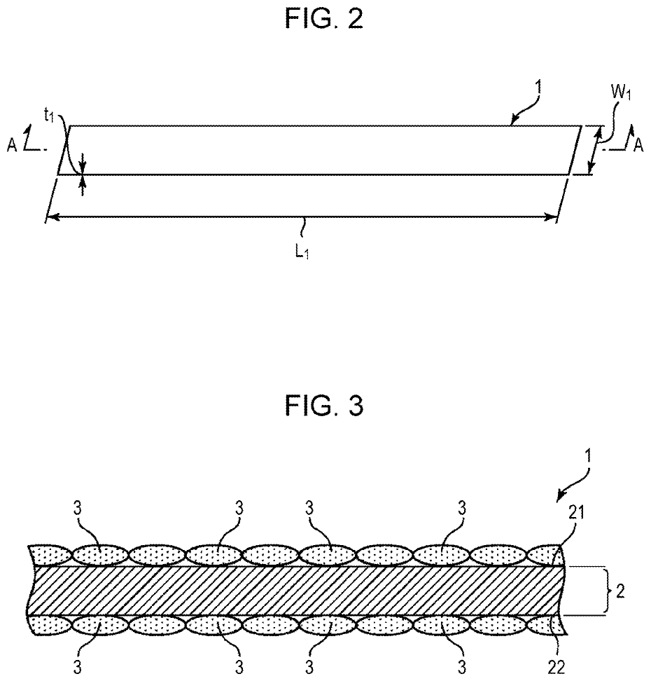

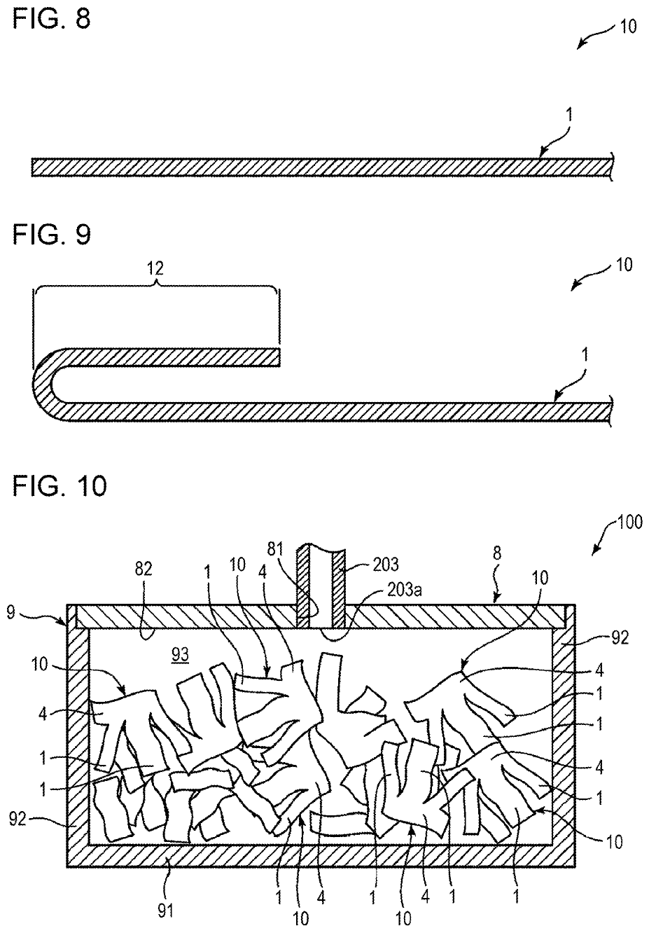

FIG. 1 is a partial vertical cross-sectional diagram illustrating an example of an ink absorbing device according to the present invention (Embodiment 1) in use. FIG. 2 is a perspective view of a chip as a member of the chip aggregate included in the ink absorbing device illustrated in FIG. 1. FIG. 3 is a cross-sectional view along line A-A in FIG. 2. In the following, words such as up, down, top, bottom, above, below, upwards, downwards, etc., are based on the vertical directions in FIGS. 1 to 3 (FIGS. 8 and 9) for the sake of description.

As illustrated in FIG. 1, an ink absorbing material according to the present invention is a chip aggregate 10. The chip aggregate 10 includes multiple chips 1 each of which is used to absorb ink Q. A chip 1 has a fiber-containing fibrous support 2 and an absorbent polymer 3 held on the fibrous support 2 (see FIG. 3).

An ink absorbing device 100 according to the present invention includes a chip aggregate 10 that is an ink absorbing material and a container 9 in which the chip aggregate 10 is packed (see FIG. 1).

This ensures that when ink Q is supplied to the chip aggregate 10, the chance of contact with the ink Q and the area of contact with the ink Q are maximized, compared with the case in which a one-piece (a sheet of) fibrous support 2 or a stack of one-piece fibrous supports 2 (sheets of material) is used as an ink absorber. The fiber (fibrous support 2), furthermore, retains the ink Q temporarily. The ink Q is then sent from the fiber to the absorbent polymer 3 more efficiently, hence improved ink Q absorption properties of the chip aggregate 10 as a whole. In addition, the chip aggregate 10 provides long-term retention of absorbed ink Q; this helps prevent the ink Q from leaking out of the ink absorber 100.

It should be noted that “absorbent” as mentioned herein naturally means that the polymer absorbs water-based inks, which are solutions of colorant(s) in an aqueous medium or media, but also embraces the ability of the polymer to absorb inks in general, including solvent-based inks, which are solutions of binder(s) in solvent(s), UV-curable inks, which are solutions of binder(s) in liquid monomer(s) that cures in response to UV irradiation, and latex inks, which are dispersions of binder(s) in a dispersion medium or media.

The printing apparatus (droplet ejecting apparatus) 200 illustrated in FIG. 1 is, for example, an ink jet color printer. This printing apparatus 200 includes an ink-ejecting head 201 that ejects ink Q, a capping unit 202 that prevents the clogging of the nozzles 201a of the ink-ejecting head 201, a tube 203 that connects the capping unit 202 and the ink absorbing device 100 together, and a roller pump 204 that sends the ink Q from the capping unit 202 to the ink absorbing device 100.

The ink-ejecting head 201 has multiple nozzles 201a each of which ejects ink Q downwards. This ink-ejecting head 201 produces a print by ejecting ink Q while moving relative to a recording medium, such as a PPC sheet (not illustrated) (see the ink-ejecting head 201 drawn with long-dash double-short-dash lines in FIG. 1).

The capping unit 202 is a component that prevents the clogging of the nozzles 201a by draining all nozzles 201a at once through the operation of the roller pump 204 while the ink-ejecting head 201 is in its standby position.

The tube 203 is a passage for the ink Q sucked there by the action of the capping unit 202 to move toward the ink absorbing device 100. This tube 203 is flexible.

The roller pump 204, positioned somewhere along the tube 203, has a roller section 204a and a holding section 204b that holds somewhere of the tube 203 together with the roller section 204a. A rotation of the roller section 204a generates suction in the capping unit 202 via the tube 203. As the roller section 204a continues to rotate, therefore, the ink Q sticking to the nozzles 201a is sent into the ink absorbing device 100. This ink Q is absorbed as waste liquid at the chip aggregate 10 (ink absorbing material) inside the ink absorbing device 100. The ink Q contains inks in different colors.

As illustrated in FIG. 1, the ink absorbing device 100 includes a chip aggregate 10 that includes multiple (many) shredded chips 1, a container 9 in which the chip aggregate 10 is packed, and a lid 8 that seals the container 9.

This ink absorbing device 100 is detachably attached to the printing apparatus 200 and is used to absorb waste ink Q as described above while attached. This makes it possible to use an ink absorbing device 100 as a so-called “waste liquid tank (waste ink tank).” After the amount of ink Q absorbed by the ink absorbing device 100 reaches its limit, furthermore, this ink absorbing device 100 can be replaced with a new (unused) ink absorbing device 100. Whether the amount of ink Q absorbed by an ink absorbing device 100 has reached its limit is detected by a detector (not illustrated) placed inside the printing apparatus 200. When the amount of ink Q absorbed by an ink absorbing device 100 reaches its limit, the user is informed by an informing section, such as a built-in monitor of the printing apparatus 200.

The container 9 is a component in which the chip aggregate 10 is packed. This container 9 is one shaped like a box, having a bottom (bottom plate) 91 that is, for example, rectangular in plan view and four side walls 92 standing upright along the sides (edges) of the bottom 91. A packing space 93 enclosed by the bottom 91 and four side walls 92 can accommodate the chip aggregate 10.

The container 9 does not need to be one having a bottom 91 that is rectangular in plan view, but may be, for example, one having a bottom 91 that is round in plan view and therefore is cylindrical as a whole.

The container 9 is a rigid one. In other words, the container 9 is one that has shape retainability high enough that it does not change its volume V1 by 10% or more when internal pressure or an external force acts thereon.

This ensures that the container 9 maintains its own shape even when the chips 1 forming the chip aggregate 10 expand by absorbing ink Q and apply force to the container 9 from inside. By virtue of this, the container 9 stays in a stable position inside the printing apparatus 200, allowing the chips 1 to absorb ink Q consistently.

The container 9 can be made of any material as long as it is made of a material impermeable to ink Q. Examples of such materials that can be used for the container 9 include resin materials, such as cyclic polyolefins and polycarbonate. Besides resin materials, metallic materials, such as aluminum and stainless steel, can also be used as materials for the container 9.

The container 9, moreover, may be a transparent (or translucent) container that one can see through or a nontransparent container.

As mentioned above, the ink absorbing device 100 includes a lid 8 that seals the container 9. As illustrated in FIG. 1, the lid 8 is shaped like a plate and engages with an upper opening 94 of the container 9. The engagement provides a liquid-tight seal of the upper opening 94. This ensures, for example, that even when ink Q that falls down after being discharged from the tube 203 splashes up by hitting the chip aggregate 10 (chips 1), the ink Q is prevented from scattering out. This helps prevent ink Q from sticking around the ink absorbing device 100 and staining there.

In the middle of the lid 8 is a connection opening 81 to which the tube 203 is connected. The connection opening 81 is a through hole that penetrates through the thickness of the lid 8. To this connection opening 81 (through hole), the downstream end (lower end) of the tube 203 can be connected by inserting it there. The outlet (opening) 203a of the tube 203 in this state faces downwards.

On the lower surface (back surface) 82 of the lid 8, there may be, for example, radial ribs or grooves around the connection opening 81. The ribs or grooves serve as, for example, a rectifier (guide) that determines the direction in which ink Q should flow inside the container 9.

The lid 8, furthermore, may have absorbency, or absorb ink Q, or may have repellency, or repel ink Q.

The thickness of the lid 8 is not critical. For example, it is preferred that the thickness of the lid 8 be 1 mm or more and 20 mm or less, more preferably 8 mm or more and 10 mm or less. The lid 8 does not need to be a plate-shaped one that falls within such numerical ranges, but may be a thinner, filmy (sheet-shaped) one. In that case, too, the thickness of the lid 8 is not critical. For example, it is preferred that the thickness of the lid 8 be 10 μm or more and less than 1 mm.

As illustrated in FIG. 1, the chip aggregate 10 includes multiple chips 1 that are flexible, and, in this embodiment, is used with these chips 1 packed all together in a container 9. This makes the chip aggregate 10 an ink absorbing device 100. As mentioned above, the ink absorbing device 100 is attached to a printing apparatus 200 and in that state is capable of absorbing waste ink Q.

The number of chips 1 forming the chip aggregate 10, or packed in the container 9, is not critical. For example, as many chips 1 as needed are selected according to the relevant conditions, such as the purpose of use of the ink absorbing device 100. The ink absorbing device 100 is therefore one that is simple in structure, as many chips 1 as needed packed in a container 9. The quantity of packed chips 1 determines the maximum amount of ink Q absorbed at the chip aggregate 10 (ink absorbing device 100).

Each chip 1 has the same structure. In the following, therefore, one chip 1 is described as a representative example.

As mentioned above, a chip 1 has a fiber-containing fibrous support 2 and an absorbent polymer 3 held on the fibrous support 2. In this embodiment, as illustrated in FIG. 3, the fibrous support 2 as a component of the chip 1 is a finely shredded, coarsely milled, or powdered piece of a sheet of paper, such as waste paper, for example made using scissors, a utility knife, a mill, or a paper shredder. The absorbent polymer 3 is adhering to at least one side of the fibrous support 2 (in the structure illustrated in FIG. 3, the front surface 21 and the back surface 22). This ensures that the absorbent polymer 3 absorbs ink Q, whichever side of the chip 1, the front surface 21 or back surface 22 side, the ink Q reaches. The absorbent polymer 3, furthermore, is exposed on the fibrous support 2. With this absorbent polymer 3, therefore, ink Q can be absorbed quickly.

For the absorbent polymer 3, the amount of adhering absorbent polymer 3 is preferably equal between the front surface 21 and back surface 22 sides, but may be different.

The absorbent polymer 3, moreover, is preferably arranged and dispersed evenly on both of the front surface 21 and back surface 22 sides, but the degree of dispersion may be sparse in some areas and dense in others.

More preferably, the degree of dispersion of the absorbent polymer 3 on the front surface 21 side and that on the back surface 22 side are equal. However, the degree of dispersion of the absorbent polymer 3 may be different between the two sides.

How to hold the absorbent polymer 3 on (attach the polymer to) the fibrous support 2 is not critical. An example is to apply water, PVA, or glue and hold the polymer therewith. How much absorbent polymer 3 should be held on the fibrous support 2 is not critical either. For example, when the weight of the fibrous support 2 exceeds 0 g and 0.24 g, it is preferred that the weight of the absorbent polymer 3 be set to be 0.04 g or more and 0.12 g or less as necessary.

By virtue of the fibrous support 2, the absorbent polymer 3 is held well, and the detachment of the absorbent polymer 3 from the fibrous support 2 is prevented better. When ink Q is supplied to the chip 1, moreover, the fiber (fibrous support 2) retains the ink Q temporarily. The ink Q is then sent to the absorbent polymer 3 more efficiently, hence improved ink Q absorption properties of the entire chip 1. In general, furthermore, fibers such as cellulose fiber (in particular, fiber recycled from waste paper) are low-priced compared with absorbent polymers 3, which makes fibers also advantageous in terms of reducing the cost of producing the chips 1. Given that fiber recycled from waste paper is suitable for use, the use of fiber is also advantageous in terms of waste minimization, effective use of resources, etc.

Examples of fibers include synthetic resin fibers, such as polyester fiber and polyamide fiber; and natural resin fibers, such as cellulose fiber, keratin fiber, and fibroin fiber, and their chemically modified versions. Such fibers can be used alone or optionally blended, but it is preferred that the fiber be primarily cellulose fiber. It is more preferred that substantially all the fiber be cellulose fiber.

Cellulose is a material of good hydrophilicity, and, when ink Q is supplied to the chip 1, it allows the chip 1 to trap the ink Q well. The ink Q therefore quickly escapes a state of being extremely fluidic (e.g., a state in which its viscosity is 10 mPa·s or less), and the chip 1 sends the temporarily trapped ink Q to the absorbent polymer 3 well. As a result, the ink Q absorption properties of the entire chip 1 are superb. By virtue of the high compatibility of cellulose with absorbent polymers 3 in general, moreover, the absorbent polymer 3 is held on the surface of the fiber better. In addition, being a renewable natural material and low-priced and readily available even when compared with other fibers, cellulose fiber is also advantageous in terms of reducing the cost of producing the chips 1, stable production of the chips 1, reducing environmental burdens, etc.

As mentioned herein, cellulose fiber only needs to be a fibrous material that is primarily the compound cellulose (cellulose in a narrow sense). Cellulose fiber may therefore be one that contains hemicelluloses and/or lignins besides cellulose (cellulose in a narrow sense).

In the fibrous support 2 (chip 1), multiple fiber threads, for example, may be present independently of each other. In the fibrous support 2, moreover, the fiber may be contained in, for example, flocculent form. The fiber may be one that has been shaped like, for example, strips or chips.

The raw material for the fiber may be, for example, waste paper. This brings such advantages as mentioned above and is also preferred in terms of saving resources. When the raw material for the fiber is waste paper, the fiber is finely shredded, coarsely milled, or powdered pieces of the waste paper, for example made using scissors, a utility knife, a mill, or a paper shredder.

The average length of the fiber threads is not critical, but it is preferred that it be 0.1 mm or more and 7 mm or less, more preferably 0.1 mm or more and 5 mm or less, even more preferably 0.1 mm or more and 3 mm or less.

The average width (diameter) of the fiber threads is not critical, but it is preferred that it be 0.5 μm or more and 200 μm or less, more preferably 1.0 μm or more and 100 μm or less.

The average aspect ratio (proportion of the average length to the average width) of the fiber threads is not critical, but it is preferred that it be 10 or more and 1000 or less, more preferably 15 or more and 500 or less.

In such numerical ranges, the hold of the absorbent polymer 3 as well as the retention of ink Q and the delivery of the ink Q to the absorbent polymer 3 by the fiber are better, hence better ink absorption properties of the entire chip 1.

The absorbent polymer 3 only needs to be a polymer that has absorbency and can be of any kind, but examples include carboxymethyl cellulose, polyacrylic acid, polyacrylamide, starch-acrylic acid graft copolymers, hydrolysates of starch-acrylonitrile graft copolymers, vinyl acetate-acrylate copolymers, polymers like copolymers of isobutylene and maleic acid, hydrolysates of acrylonitrile copolymers or acrylamide copolymers, polyethylene oxide, polysulfonic-acid compounds, and polyglutamic acid and their salts (neutralized derivatives) and crosslinked forms. Here, absorbency refers to the ability to have hydrophilicity and retain water. Many of absorbent polymers 3 gel once they absorb water.

For the absorbent polymer 3, polymers having a pendant functional group are particularly preferred. Examples of functional groups include acid groups, the hydroxyl group, the epoxy group, and the amino group.

It is particularly preferred that the absorbent polymer 3 be a polymer having a pendant acid group, more preferably a polymer having a pendant carboxyl group.

Examples of carboxyl-containing units as a component of the absorbent polymer 3 include those derived from monomers such as acrylic acid, methacrylic acid, itaconic acid, maleic acid, crotonic acid, fumaric acid, sorbic acid, and cinnamic acid and their anhydrides and salts.

When an absorbent polymer 3 having a pendant acid group is contained, the percentage of acid groups in the absorbent polymer 3 neutralized to form a salt is preferably 30 mol % or more and 100 mol % or less, more preferably 50 mol % or more and 95 mol % or less, even more preferably 60 mol % or more and 90 mol % or less, the most preferably 70 mol % or more and 80 mol % or less. This leads to better ink Q absorbency of the absorbent polymer 3 (chip 1).

The salt of neutralization can be of any kind. Examples include alkali metal salts, such as the sodium salt, the potassium salt, and the lithium salt, and salts of nitrogen-containing basic compounds, such as ammonia, but the sodium salt is preferred. This leads to better ink Q absorbency of the absorbent polymer 3 (chip 1).

The preference for absorbent polymers 3 having a pendant acid group is because electrostatic repulsion between acid groups that occurs upon ink absorption accelerates the rate of absorption. The state in which acid groups have been neutralized, moreover, makes the ink Q easily absorbed into the absorbent polymer 3 by virtue of osmotic pressure.

The absorbent polymer 3 may have a constituent containing no acid group. Examples of such constituents include hydrophilic constituents, hydrophobic constituents, and constituents that serve as polymerizable crosslinkers.

Examples of hydrophilic constituents include constituents derived from nonionic compounds, such as acrylamide, methacrylamide, N-ethyl (meth)acrylamide, N-n-propyl (meth)acrylamide, N-isopropyl (meth)acrylamide, N,N-dimethyl (meth)acrylamide, 2-hydroxyethyl (meth)acrylate, 2-hydroxypropyl (meth)acrylate, methoxypolyethylene glycol (meth)acrylate, polyethylene glycol mono(meth)acrylate, N-vinylpyrrolidone, N-acryloylpiperidine, and N-acryloylpyrrolidine.

Examples of hydrophobic constituents include constituents derived from compounds such as (meth)acrylonitrile, styrene, vinyl chloride, butadiene, isobutene, ethylene, propylene, stearyl (meth)acrylate, and lauryl (meth)acrylate.

Examples of constituents that serve as polymerizable crosslinkers include diethylene glycol diacrylate, N,N′-methylenebisacrylamide, methylenebisacrylamide, polyethylene glycol diacrylate, polypropylene glycol diacrylate, trimethylolpropane diallyl ether, trimethylolpropane triacrylate, allyl glycidyl ether, pentaerythritol triallyl ether, pentaerythritol diacrylate monostearate, bisphenol diacrylate, isocyanuric acid diacrylate, tetraallyloxyethane, and diallyloxyacetates.

Preferably, the absorbent polymer 3 contains a polyacrylate copolymer or crosslinked polyacrylic-acid polymer. This brings advantages such as improved performance on absorbing ink Q and the possibility of reduced production cost.

A crosslinked polyacrylic-acid polymer is preferably one in which the percentage of constituents having a carboxyl group to all constituents forming the molecular chain is 50 mol % or more, more preferably 80 mol % or more, even more preferably 90 mol % or more.

Too low a percentage of carboxyl-containing constituents can make it difficult to achieve sufficiently good performance on absorbing ink Q.

Preferably, a subset of the carboxyl groups in the crosslinked polyacrylic-acid polymer have been neutralized (the polymer has been partially neutralized) to form a salt.

The percentage of neutralized carboxyl groups to all carboxyl groups in the crosslinked polyacrylic-acid polymer is preferably 30 mol % or more and 99 mol % or less, more preferably 50 mol % or more and 99 mol % or less, even more preferably 70 mol % or more and 99 mol % or less.

The absorbent polymer 3, moreover, may have a structure crosslinked with a crosslinker that is not a polymerizable crosslinker as mentioned above.

When the absorbent polymer 3 is a polymer having an acid group, compounds having multiple functional groups that react with acid groups, for example, are preferred for use as crosslinkers.

When the absorbent polymer 3 is a polymer having a functional group that reacts with acid groups, compounds having multiple functional groups that react with acid groups are suitable for use as crosslinkers.

Examples of compounds (crosslinkers) having multiple functional groups that react with acid groups include glycidyl ether compounds, such as ethylene glycol diglycidyl ether, trimethylolpropane triglycidyl ether, (poly)glycerol polyglycidyl ether, diglycerol polyglycidyl ether, and propylene glycol diglycidyl ether; polyhydric alcohols, such as (poly)glycerol, (poly)ethylene glycol, propylene glycol, 1,3-propanediol, polyoxyethylene glycol, triethylene glycol, tetraethylene glycol, diethanolamine, and triethanolamine; and polyamines, such as ethylenediamine, diethylenediamine, polyethyleneimine, and hexamethylenediamine. Substances like polyvalent ions, such as zinc, calcium, magnesium, and aluminum, are also suitable for use because they serve as crosslinkers by reacting with the acid group the absorbent polymer 3 has.

The absorbent polymer 3 may be in any shape, for example flake-shaped, needle-like, fibrous, or particulate, but preferably is particulate. A particulate absorbent polymer 3 helps ensure permeability to ink Q easily, and also provides a good hold of the absorbent polymer 3 on the fibrous support 2 (fiber). Preferably, the average diameter of the particles is 15 μm or more and 800 μm or less, more preferably 15 μm or more and 400 μm or less, even more preferably 15 μm or more and 50 μm or less.

The average diameter of the particles can be, for example, the mean volume diameter, or MVD, as measured using a laser-diffraction particle size distribution analyzer. A particle size distribution analyzer based on laser diffraction/scattering, or a laser-diffraction particle size distribution analyzer, provides volume-based measurement of particle size distribution.

Preferably, the absorbent polymer 3 relative to the fibrous support 2 is more than 5% by weight and 90% by weight or less, more preferably 20% by weight or more and 70% by weight or less, even more preferably 40% by weight or more and 55% by weight or less.

In addition, when the average diameter of the particles of the absorbent polymer 3 is D [μm], and the aforementioned average length of fiber threads is L [μm], it is preferred that 0.15≤L/D≤467. More preferably, 0.25≤L/D≤333. Even more preferably, 2≤L/D≤200.

The chip 1, furthermore, may contain ingredients other than those described above (extra ingredients). Examples of such ingredients include surfactants, lubricants, defoamers, fillers, anti-blocking agents, ultraviolet absorbers, coloring agents, such as pigments and dyes, flame retardants, and flow improvers.

The absorbent polymer 3 in the configuration illustrated in FIG. 3 is adhering to the front surface 21 and back surface 22 of the fibrous support 2, but this is not the only possible option. For example, the absorbent polymer 3 on one of the front surface 21 and the back surface 22 may be omitted.

The chip 1, furthermore, may be one that has an intermediate layer between the fibrous support 2 and the absorbent polymer 3. This intermediate layer can be of any kind. For example, it can be a layer that promotes bonding between the fibrous support 2 and the absorbent polymer 3.

Preferably, each chip 1 is elongated one (belt-shaped) as illustrated in FIGS. 1 and 2. This makes the chips 1 deform easily. When these chips 1 (chip aggregate 10) are packed into a container 9, the chips 1 deform whatever the internal shape of the container 9 is, or displays shape compliance, ensuring that the chip aggregate 10 is packed all together smoothly. The area of contact of the chip aggregate 10 as a whole with ink Q, moreover, is maximized, hence improved absorption performance (absorption properties) on absorbing ink Q. In addition, the smooth packing of the chips 1 (chip aggregate 10) prevents excessive deformation; as a result, the detachment of the absorbent polymer 3 from the fibrous support 2 is also prevented.

When the chips 1 are produced from waste paper, or paper that has been used, the waste paper is, for example, put into a paper shredder. The resulting shreds (cut pieces) can be used as fibrous supports 2 of the chips 1.

The total length (longitudinal length) L of the chip 1 is preferably 50 mm or more and 500 mm or less for example, more preferably 100 mm or more and 300 mm or less, although depending partly on the shape and size of the container 9 (see FIG. 2).

Likewise, the width (transverse length) W₁ of the chip 1 is preferably 50 mm or more and 500 mm or less for example, more preferably 100 mm or more and 300 mm or less, although depending partly on the shape and size of the container 9 (see FIG. 2).

The aspect ratio L₁/W₁ between the total length L₁ and the width W₁ is preferably 1.1 or more and 200 or less, more preferably 2 or more and 50 or less. The thickness t₁ of the chip 1, too, is preferably 50 μm or more and 2 mm or less for example, more preferably 0.1 mm or more and 1 mm or less (see FIG. 2).

The chip aggregate 10 may include chips 1 that are equal in at least one of total length L₁, width W₁, aspect ratio L₁/W, and thickness t₁, or may include chips 1 differing in all of these.

The shape of the chip 1 is elongated in this embodiment, but this is not the only possible option. For example, the shape of the chip 1 may be polygonal, such as square, triangle, or hexagonal, or a shape like a circle or oval, or even irregular like that of a hand-torn piece. It may even be that sets of chips 1 varying in shape and/or size intermingle.

As mentioned above, each chip 1 is elongated one (has a longitudinal dimension). Inside the container 9, the chips 1 are loaded in such a manner that each of them extends in different directions as illustrated in FIG. 1. That is, multiple chips 1 are present irregularly but as an aggregate in the container 9 so that the directions in which the chips 1 extend are not aligned (not parallel) but cross together. In other words, the chips 1 are packed randomly (with or without order; the same applies hereinafter) in two-dimensional directions (e.g., the direction along the bottom 91 (lower surface 82)) or three-dimensional directions (the three directions in the packing space 93) inside the container 9. In such a packing state, it is likely that gaps 20 are created between the chips 1. By virtue of this, ink Q can pass through the gaps 20 and, when the gaps 20 are microscopic, can spread by capillarity; that is, permeability to ink Q is guaranteed. This prevents the ink Q flowing downwards inside the container 9 from being interrupted, thereby allowing the ink Q to penetrate to the depths (bottom 91) of the container 9. This ensures equal absorption and long-term retention of the ink Q by the chips 1. The random packing of the chips 1 also increases the chance of contact of the chip aggregate 10 as a whole with ink Q; therefore, absorption performance on absorbing ink Q is improved. When the chip aggregate 10 is packed into a container 9, furthermore, the chips 1 can be put into the container 9 randomly; therefore, the packing work is easy and quick.

In addition, when the volume of the container 9 (packing space 93) is V1, and the total volume of the chip aggregate 10 that has yet to absorb ink Q (yet to absorb water) is V2, the ratio V2/V1 between V1 and V2 is preferably 0.1 or more and 0.7 or less, more preferably 0.2 or more and 0.7 or less (see FIG. 1). This creates a void 95 inside the container 9. The chips 1 expand (swell) after absorbing ink Q. The void 95 serves as a buffer when the chips 1 expand, thereby allowing the chips 1 to absorb sufficient ink Q.

### Embodiment 2

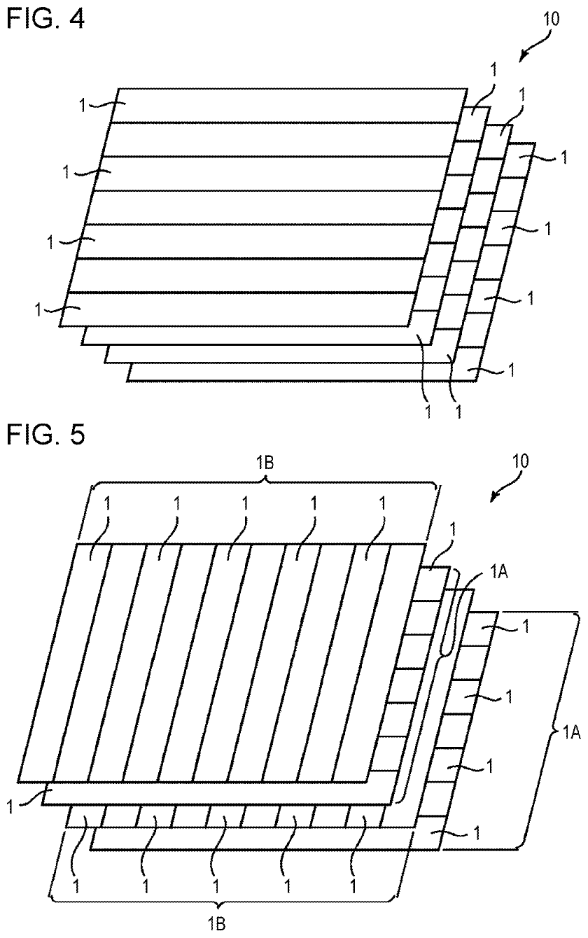

FIG. 4 is an exploded perspective diagram illustrating the relative positions of chip aggregates to be packed in an ink absorbing device according to the present invention.

The following describes an ink absorbing material, an ink absorbing device, and a droplet ejecting apparatus according to the present invention in Embodiment 2 with reference to this drawing. The following description, however, is centered on differences from the above embodiment, leaving out the description of similarities.

This embodiment is the same as Embodiment 1 above except that the chips are packed in the container in another way.

As illustrated in FIG. 4, each chip 1 is elongated one (one that has a longitudinal dimension). In the container 9, multiple chips 1 are present with all extending in the same horizontal direction (one particular direction) in FIG. 4. That is, the chips 1 are arranged regularly inside the container 9. Overlapping chips 1 are also included. Such a state of packing of chips 1 is an effective configuration, for example when ink Q flows down toward the bottom 91 inside the container 9 and the user wants to reduce its downflow speed (penetration speed).

It should be noted that the chip aggregate 10 includes multiple chips 1 that are regularly arranged, but besides these, it may include, for example, multiple chips 1 that are randomly arranged as described in Embodiment 1 above.

### Embodiment 3

FIG. 5 is an exploded perspective diagram illustrating the relative positions of chip aggregates to be packed in an ink absorbing device according to the present invention.

The following describes an ink absorbing material, an ink absorbing device, and a droplet ejecting apparatus according to the present invention in Embodiment 3 with reference to this drawing. The following description, however, is centered on differences from the above embodiments, leaving out the description of similarities.

This embodiment is the same as Embodiment 2 above except that the chips are packed in the container in another way.

As illustrated in FIG. 5, the chip aggregate 10 in the container 9 includes groups of chips 1 in which all chips 1 extend in the same horizontal direction in FIG. 5 (hereinafter referred to as “first chip groups 1A”) and those in which all chips 1 extend in the same, upper right-to-lower left direction in FIG. 5 (hereinafter referred to as “second chip groups 1B”). That is, the direction in which the chips 1 in the first chip groups 1A extend and that in which the chips 1 in the second chip groups 1B extend are at right angles. The first chip groups 1A and the second chip groups 1B, moreover, are alternated. Such a state of packing of chips 1 is an effective configuration, for example when the user wants to further reduce the downflow speed of the ink Q from that in Embodiment 2.

### Embodiment 4

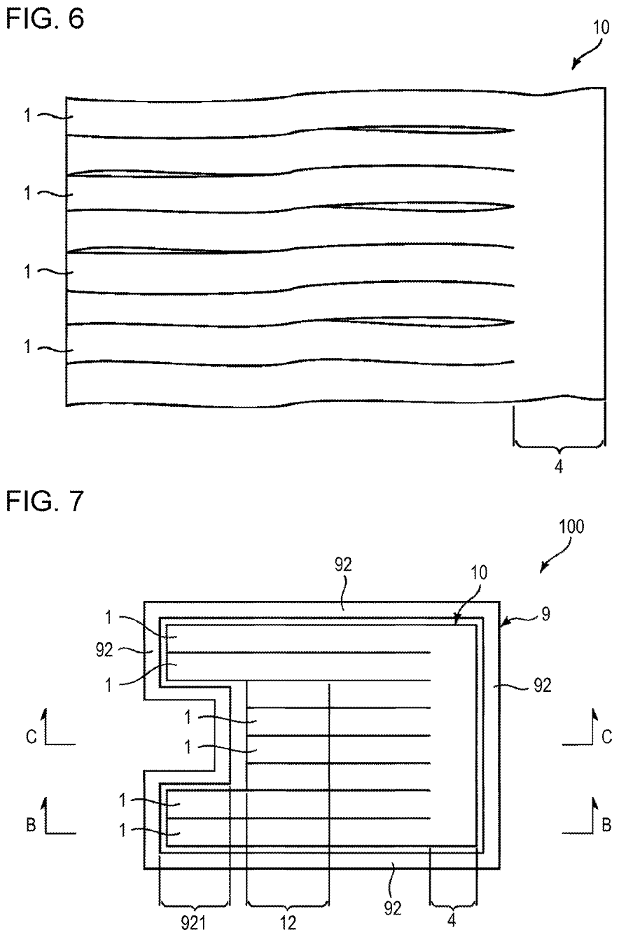

FIG. 6 is a plan view of a chip aggregate to be packed in an ink absorbing device according to the present invention. FIG. 7 is a plan diagram illustrating the chip aggregate of FIG. 6 in a container. FIG. 8 is a cross-sectional view along line B-B in FIG. 7. FIG. 9 is a cross-sectional view along line C-C in FIG. 7. FIG. 10 is a vertical cross-sectional diagram illustrating a variation of chip aggregates packed in an ink absorbing device according to the present invention.

The following describes an ink absorbing material, an ink absorbing device, and a droplet ejecting apparatus according to the present invention in Embodiment 4 with reference to these drawings. The following description, however, is centered on differences from the above embodiments, leaving out the description of similarities.

This embodiment is the same as Embodiment 1 above except that it has a different configuration of chip aggregates.

As illustrated in FIG. 6, a chip aggregate 10 in this embodiment has a connector 4 that connects multiple chips 1 (in particular, their ends) together. This ensures that when the chip aggregate 10 is packed into a container 9, multiple chips 1 can be put into the container 9 by holding the connector 4 and casting it together with the connected chips 1. As a result, the packing of the chip aggregate 10 into the container 9 is easy and quick.

Preferably, the connector 4 also has a fiber-containing fibrous support 2 and an absorbent polymer 3 held on the fibrous support 2 like the chip 1. That is, the connector 4 can be made by preparing a piece of paper material (sheet), making multiple parallel slits (cuts) from a first end toward a second end, and stopping cutting partway (before the cuts reach the second end). The multiple chips 1 therefore form a chip aggregate 10 as a result of serial connection of their second ends along the transverse dimension of the chips. Alternatively, the connector 4 may be a separate component, such as a piece of paper tape, a stapler, or any other binding tool.

The number of chips 1 connected by the connector 4 is eight in this embodiment, but does not need to be this as long as it is two or more.

The connector 4, moreover, does not need to be one that connects the second ends of chips 1 together. For example, the connector 4 may be one that connects somewhere along the longitudinal dimension of the chips 1 (part of each chip 1) together. In this case, too, the packing of the chip aggregate 10 into the container 9 is easy and quick.

In the container 9, one sheet connected by the connector 4 (chip aggregate 10) may be packed, or a stack of more than one of such sheets may be packed.

In the container 9, furthermore, multiple chips 1 may be packed separately from (independently of) each other. In this case, the container 9 may contain multiple chips 1 that are arranged as described in Embodiment 1 above, or may contain multiple chips 1 that are regularly arranged as described in Embodiment 2 above.

As illustrated in FIG. 7, the container 9 in this embodiment has a protrusion 921 sticking (projecting) toward the inside on one side wall 92 of the four side walls 92. The opposite of this protrusion 921 is recessed to provide, for example, an escape space that prevents the ink absorbing device 100 from interfering with surrounding components when installed in a printing apparatus 200.

The container 9 in this embodiment has a protrusion 921 on one side wall 92 of the four side walls 92, but this is not the only possible option. For example, there may be a protrusion 921 on two, three, or four (all) side walls 92.

As mentioned above, each chip 1 is elongated one. In the container 9, moreover, these chips 1 include folded ones. That is, the multiple chips 1 include ones that have a folded portion 12 created by folding the end opposite the connector 4 (see FIGS. 7 and 9). This folded portion 12 adjusts the length of the chips 1 inside the container 9, preventing the chips 1 from interfering with the protrusion 921. By virtue of this, it is easy to pack the chip aggregate 10 into the container 9. The packed chip aggregate 10 is also stable. Those chips 1 that have a folded portion 12, furthermore, have an increased (adjusted) thickness inside the container 9 proportionally to the folding.

The chips 1 other than those chips 1 that have a folded portion 12 are straight at the end opposite the connector 4 (see FIG. 8).

Meanwhile, inside the variation container 9 illustrated in FIG. 10, multiple chip aggregates 10 are packed each having a connector 4 that connects multiple chips 1 together, and they are packed randomly in two-dimensional directions or three-dimensional directions. In each chip aggregate 10, the chips 1 may be folded or twisted; that is, they may have been deformed to the desired shape. Such a packing state also provides quick absorption of ink Q.

### Embodiment 5

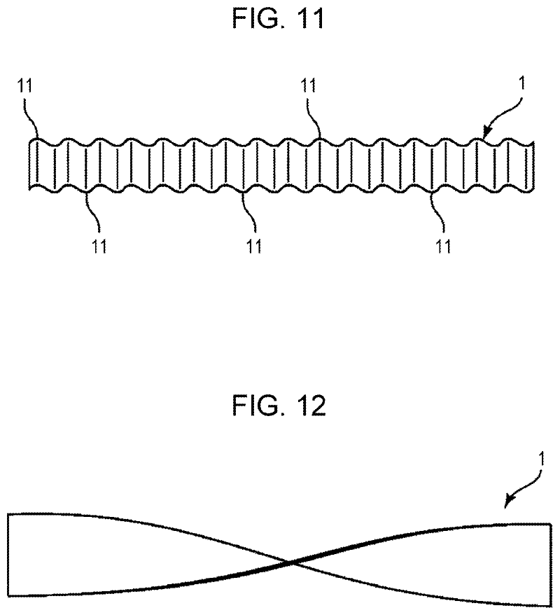

FIG. 11 is a perspective view of a chip as a member of a chip aggregate included in an ink absorbing device according to the present invention.

The following describes an ink absorbing material, an ink absorbing device, and a droplet ejecting apparatus according to the present invention in Embodiment 5 with reference to this drawing. The following description, however, is centered on differences from the above embodiments, leaving out the description of similarities.

This embodiment is the same as Embodiment 1 above except that the shape of the chips is different.

As illustrated in FIG. 11, the chips 1 in this embodiment have bends (folds) 11 that bend (or curve) the longitudinal dimension of the chips 1 back and forth multiple times, in the opposite direction from time to time. That is, the chips 1 are corrugated. Such deformed chips 1 are obtained by, for example, bulking. This makes the chips 1 bulky ones, thereby increasing the chance of contact with ink Q per chip 1. As a result, the amount of ink Q absorbed is maximized.

The bends 11 may be portions made by bending the width dimension of the chips 1 back and forth, in the opposite direction from time to time.

Making multiple bends 11 is not the only possible option; the number of bends 11 may be one.

### Embodiment 6

FIG. 12 is a perspective view of a chip as a member of a chip aggregate included in an ink absorbing device according to the present invention.

The following describes an ink absorbing material, an ink absorbing device, and a droplet ejecting apparatus according to the present invention in Embodiment 6 with reference to this drawing. The following description, however, is centered on differences from the above embodiments, leaving out the description of similarities.

This embodiment is the same as Embodiment 5 above except that the shape of the chips is different.

As illustrated in FIG. 12, the chips 1 in this embodiment are ones that have at least one twist somewhere along their longitudinal dimension. This makes the chips 1 bulky ones, thereby increasing the chance of contact with ink Q per chip 1. As a result, the amount of ink Q absorbed is maximized.

Twist(s) and the aforementioned bend(s) 11 may intermingle in one single chip 1. Alternatively, the chip aggregate 10 may be one that includes at least two types of chips 1 having the shape in FIG. 2, those having the shape in FIG. 11, and those having the shape in FIG. 12 as needed.

### Embodiment 7

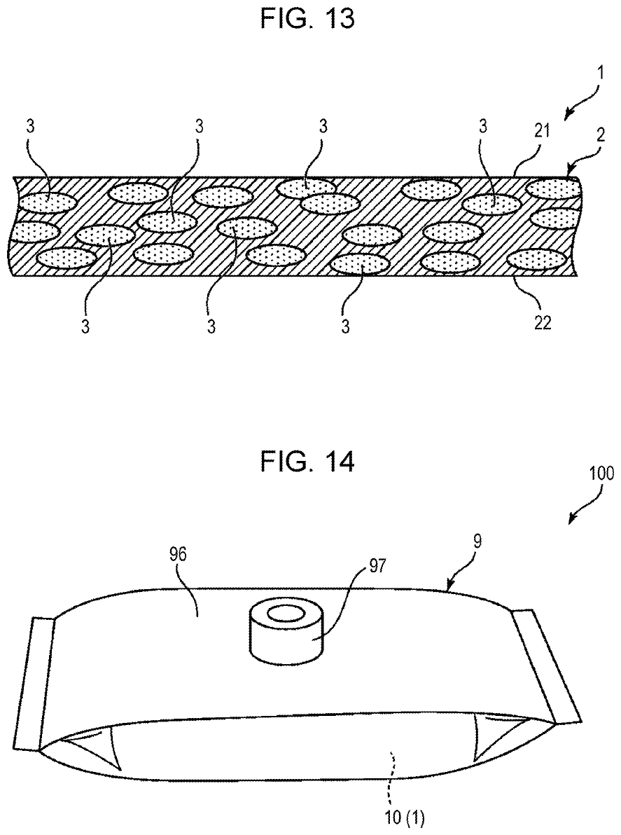

FIG. 13 is a vertical cross-sectional view of a chip as a member of a chip aggregate included in an ink absorbing device according to the present invention.

The following describes an ink absorbing device according to the present invention with reference to these drawings. The following description, however, is centered on differences from the above embodiments, leaving out the description of similarities.

This embodiment is the same as Embodiment 1 above except that the relative positions of the fibrous support and the absorbent polymer are different.

As illustrated in FIG. 13, the absorbent polymer 3 with the fibrous support 2 in this embodiment is somewhere in the thickness dimension of the fibrous support 2. That is, the absorbent polymer is spread inside the fibrous support 2 in the direction of thickness. This ensures that ink Q is retained (absorbed) as close to the middle of the sheets 1 in the direction of their thickness as it can be, hence extended retention of the ink Q. The detachment of the absorbent polymer 3 from the fibrous support 2 is also prevented.

The absorbent polymer 3 may be dispersed evenly in the direction of thickness or may be localized at the front surface 21 or back surface 22 of the fibrous support 2.

In addition, the combination with the configuration illustrated in FIG. 3 is permitted; that is, the absorbent polymer 3 may be present on (adhering to) at least one side of the fibrous support 2 (front surface 21 and/or back surface 22), too.

### Embodiment 8

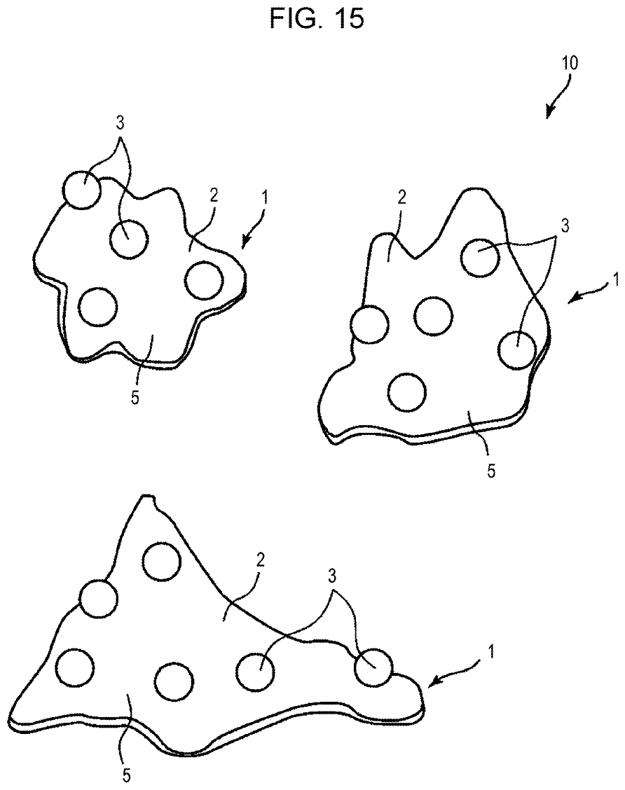

FIG. 14 is a perspective diagram illustrating an ink absorbing device according to the present invention.

The following describes an ink absorbing material, an ink absorbing device, and a droplet ejecting apparatus according to the present invention with reference to this drawing. The following description, however, is centered on differences from the above embodiments, leaving out the description of similarities.

This embodiment is the same as Embodiment 1 above except that the structure of the container is different.

As illustrated in FIG. 14, the container 9 in this embodiment is a flexible one, i.e., a soft and bag-shaped one. In other words, the container 9 is one that has shape retainability low enough that it changes its volume V1 by 10% or more when internal pressure or an external force acts thereon. In FIG. 14, the ink absorbing device 100 is a “pillow-packed” one. Such a container 9 can be deformed as needed in the place where the ink absorbing device 100 is installed. By virtue of this, the ink absorbing device 100 stays in a stable position, allowing the chips 1 (chip aggregate 10) to absorb ink Q consistently. Even when the chips 1 expand by absorbing ink Q, furthermore, the container 9 deforms to follow the expansion. This embodiment also contributes to reducing the weight of the ink absorbing device 100 (container 9).

In the middle of the top surface 96 of the container 9 is a connection port 97 to which the tube 203 is connected. This connection port 97 is tube-shaped and has been formed to stick upwards.

The material for the container 9 is not critical. Examples include polyolefins, such as polyethylene and ethylene-vinyl acetate (EVA) copolymers, polyesters, such as polyethylene terephthalate (PET) and polybutylene terephthalate (PBT), and thermoplastic elastomers, such as polyurethane.

The foregoing description of ink absorbing materials, ink absorbing devices, and droplet ejecting apparatuses according to the present invention in illustrated embodiments does not mean the present invention is limited to them. Each structural element of the ink absorbing materials, ink absorbing devices, and droplet ejecting apparatuses can be replaced with one having any other configuration that provides the same function. There may be any component added to it.

An ink absorbing material, an ink absorbing device, and a droplet ejecting apparatus according to the present invention, furthermore, may be combinations of any two or more configurations (features) in the above embodiments.

In addition, the use of the ink absorbing devices according to the present invention in the above embodiments is a “waste liquid tank (waste ink tank),” but this is not the only possible option. For example, it may be a “receiver for ink leakages” that absorbs ink that has accidentally leaked out of an ink channel of a printing apparatus.

### Embodiment 9

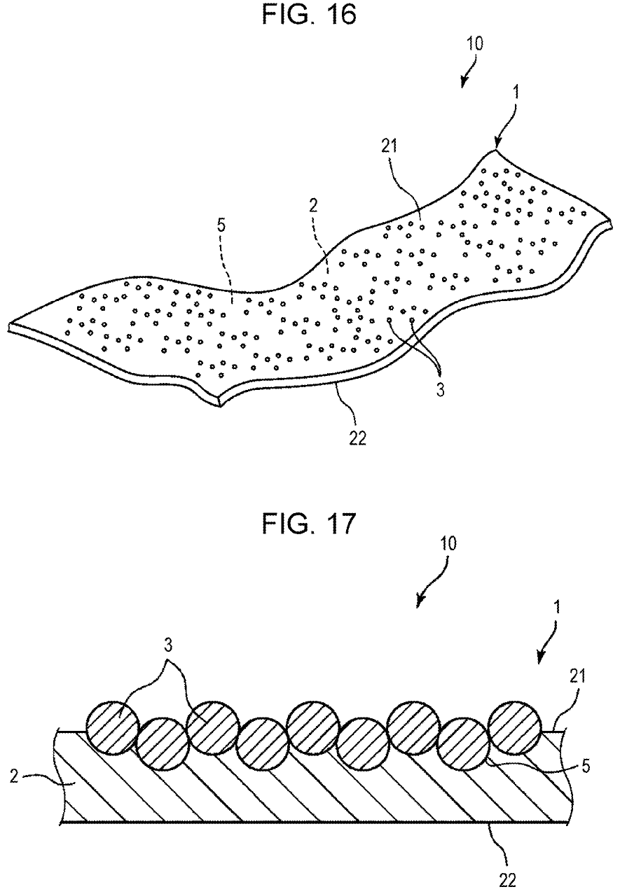

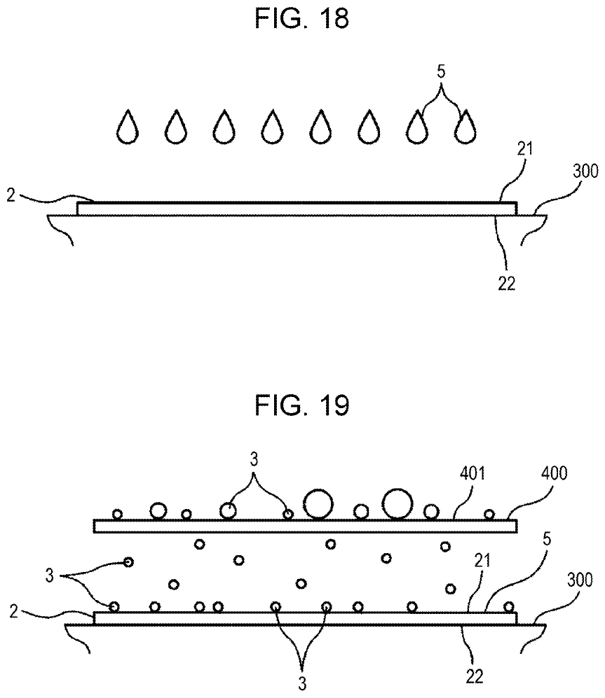

FIG. 15 is a perspective diagram illustrating an exemplary form of an ink absorbing material according to the present invention. FIG. 16 is a perspective view of the ink absorbing material illustrated in FIG. 15. FIG. 17 is a cross-sectional view of the ink absorbing material illustrated in FIG. 15. FIG. 18 is a diagram illustrating a production process for the production of the ink absorbing material illustrated in FIG. 15, illustrating the application of an adhesive agent. FIG. 19 is a diagram illustrating a production process for the production of the ink absorbing material illustrated in FIG. 15, illustrating the supply of an absorbent polymer. FIG. 20 is a diagram illustrating a production process for the production of the ink absorbing material illustrated in FIG. 15, illustrating the heating and compression of a sheet-shaped fibrous support. An ink absorbing device that includes the chips (ink absorbing material) of the ink absorbing device illustrated in FIG. 15 has the same cross-sectional view as FIG. 1 for Embodiment 1.

As illustrated in FIGS. 15 to 17, the ink absorbing material 10 is a chip aggregate 10 that includes multiple chips 1 each having a fiber-containing fibrous support 2 and an absorbent polymer 3 at least part of which is spread inside the fibrous support 2.

This ensures that when ink Q is supplied to the chip aggregate 10, the chance of contact between the chips 1 and the ink Q and the area of contact between the ink Q and the chips 1 are greater than when the ink absorbing material is made with a fibrous support formed as plate-shaped (sheet-shaped) blocks. In this state, the fiber (fibrous support 2) retains the ink Q temporarily. The ink Q can then be sent from the fiber to the absorbent polymer 3 more efficiently, hence improved ink Q absorption properties of the chip aggregate 10 as a whole.

Being a chip aggregate 10 including multiple chips 1, furthermore, the ink absorbing material 10 can change its shape freely. This means the desired amount (appropriate amount) of it can be packed into the container 9 (see FIG. 1), and, for example, its bulk density is easily adjustable. As a result, unevenness in ink Q absorption properties is prevented.

Since the absorbent polymer 3 has at least in part spread inside the fibrous support 2, furthermore, the absorbent polymer 3 does not easily separate from the fibrous support 2. This allows the ink absorbing material 10 to exhibit high ink Q absorption properties as mentioned above for a long period of time and helps prevent the detachment of the absorbent polymer 3 inside the container 9. Uneven distribution of the absorbent polymer 3 inside the container 9 is therefore prevented. As a result, unevenness in ink Q absorption properties is prevented.

It should be noted that “absorbent” as mentioned herein naturally means that the polymer absorbs water-based inks, which are solutions of colorant(s) in an aqueous medium or media, but also embraces the ability of the polymer to absorb inks in general, including solvent-based inks, which are solutions of binder(s) in solvent(s), UV-curable inks, which are solutions of binder(s) in liquid monomer(s) that cures in response to UV irradiation, and latex inks, which are dispersions of binder(s) in a dispersion medium or media.

In the chip aggregate 10, each chip 1 has substantially the same structure. In the following, therefore, one chip 1 is described as a representative example.

A chip 1 has a fiber-containing fibrous support 2 and an absorbent polymer 3 held on the fibrous support 2 as mentioned above, and also has an adhesive agent 5. In this embodiment, most of the pieces of the fibrous support 2 are strip-shaped, i.e., rectangular in plan view.

The absorbent polymer 3 is held on one side of the fibrous support 2 (in the structure illustrated in FIG. 17, the front surface 21). By virtue of this, the ink Q that reaches the front surface 21 is absorbed, and the ink Q that reaches the back surface 22 is spread (allowed to permeate) quickly.

The fibrous support 2 may hold the absorbent polymer 3 on its back surface 22, too. In that case, it is preferred that the amount of adhering absorbent polymer 3 differ between the front surface 21 and the back surface 22. This ensures good absorption and spread of ink Q.

By virtue of the fibrous support 2, the absorbent polymer 3 is held well, and the detachment of the absorbent polymer 3 from the fibrous support 2 is prevented better. When ink Q is supplied to the chip 1, moreover, the fiber (fibrous support 2) retains the ink Q temporarily. The ink Q is then sent to the absorbent polymer 3 more efficiently, hence improved ink Q absorption properties of the entire chip 1. In general, furthermore, fibers such as cellulose fiber (in particular, fiber recycled from waste paper) are low-priced compared with absorbent polymers 3, which makes fibers also advantageous in terms of reducing the cost of producing the chips 1. The use of fiber is also advantageous in terms of waste minimization, effective use of resources, etc.

The fiber can be selected from the same types of fibers as described in Embodiment 1. Cellulose is a material of good hydrophilicity, and, when ink Q is supplied to the chip 1, it allows the chip 1 to trap the ink Q well. The ink Q therefore quickly escapes a state of being extremely fluidic (e.g., a state in which its viscosity is 10 mPa·s or less), and the chip 1 sends the temporarily trapped ink Q to the absorbent polymer 3 well. As a result, the ink Q absorption properties of the entire chip 1 are superb. By virtue of the high compatibility of cellulose with absorbent polymers 3 in general, moreover, the absorbent polymer 3 is held on the surface of the fiber better. In addition, being a renewable natural material and low-priced and readily available even when compared with other fibers, cellulose fiber is also advantageous in terms of reducing the cost of producing the chips 1, stable production of the chips 1, reducing environmental burdens, etc.

For the average length of the fiber threads, the average width (diameter) of the fiber threads, and the average aspect ratio (proportion of the average length to the average width) of the fiber threads, what is described in Embodiment 1 applies the same way.

In such numerical ranges, the hold of the absorbent polymer 3 as well as the retention of ink Q and the delivery of the ink Q to the absorbent polymer 3 by the fiber are better, hence better ink absorption properties of the entire chip 1. For the absorbent polymer 3, those that are described in Embodiment 1 can be used in the same way; therefore, its details are left out in the following description.

Preferably, the absorbent polymer 3 is particulate. A granular polymer refers to one whose aspect ratio (ratio between the largest length and the least length), is 0.3 or more and 1.0 or less. The average diameter of the chips is preferably 50 μm or more and 800 μm or less, more preferably 100 μm or more and 600 μm or less, even more preferably 200 μm or more and 500 μm or less.

The chip 1, like that described in Embodiment 1, may contain ingredients other than those described above (extra ingredients).

As illustrated in FIG. 17, furthermore, the absorbent polymer 3 is held on (bound to) one side of the fibrous support 2. The absorbent polymer 3, moreover, has partly penetrated into the fibrous support 2 from this side. That is, part of the absorbent polymer 3 is spread inside the fibrous support 2. This strengthens the hold of the absorbent polymer 3 on the fibrous support 2. The detachment of the absorbent polymer 3 inside the container 9 is therefore prevented. As a result, the ink absorbing material 10 exhibits its high ink absorption properties for a long period of time, and helps prevent the absorbent polymer 3 from detaching inside the container 9, and uneven distribution of the absorbent polymer 3 inside the container 9 is therefore prevented, unevenness in ink Q absorption properties is prevented.

“Having spread inside” as mentioned herein refers to an embedded (buried) state in which at least part of the particles of the absorbent polymer 3 has penetrated into the fibrous support 2 from its surface. Not all particles need to have spread. “Having spread inside” also includes the state in which particles of the absorbent polymer 3 have been softened to penetrate completely through the fibrous support 2, sticking out on the back surface of the fibrous support 2.

Preferably, the absorbent polymer 3 content of the chip 1 is 25% by weight or more and 300% by weight of less, more preferably 50% by weight or more and 150% by weight or less, of the fiber. This helps ensure sufficient water absorption and permeability.

When the absorbent polymer 3 content of the chip 1 is too small, water absorption can be insufficient. When the absorbent polymer 3 content of the chip 1 is too large, the coefficient of expansion of the chip 1 tends to be so high that permeability may be low.

The ink absorbing material 10, furthermore, includes an adhesive agent 5. The adhesive agent 5 is a component that sticks the fibrous support 2 and the absorbent polymer 3 together and also sticks pieces of the absorbent polymer 3 and fiber threads together. This strengthens the hold of the absorbent polymer 3 on the fibrous support 2, ensuring that the absorbent polymer 3 does not easily detach from the fiber. It is therefore more certain that the aforementioned effects are produced.

The adhesive agent 5 can be water, a water-soluble adhesive agent, an organic adhesive agent, etc. When the adhesive agent 5 is a water-soluble adhesive agent, the absorption of ink Q by the absorbent polymer 3 is not inhibited by the water-soluble adhesive agent. Even when the ink Q is water-based and the water-soluble adhesive agent is on the surface of the absorbent polymer 3, the water-soluble adhesive agent dissolves upon contact of the ink Q with the adhesive agent 5.

Examples of water-soluble adhesive agents include proteins, such as casein, soy protein, and synthetic proteins, starches, such as starch and oxidized starch, polyvinyl alcohols including modified polyvinyl alcohols, such as polyvinyl alcohol, cationic polyvinyl alcohols, and silyl-modified polyvinyl alcohols, cellulose derivatives, such as carboxymethyl cellulose and methyl cellulose, water-based polyurethane resins, and water-based polyester resins.

Of such adhesive agents, the use of polyvinyl alcohol is particularly preferred in terms of surface strength. This ensures the strength of the bonding between the fibrous support 2 and the absorbent polymer 3 is sufficiently high.

In addition, selecting the type of adhesive agent according to the ink Q to be absorbed ensures that the above effects are produced regardless of the type of ink Q.

Preferably, the adhesive agent 5 content of the chip 1 is 1.0% by weight or more and 70% by weight or less, more preferably 2.5% by weight or more and 50% by weight or less, of the fiber. This makes the advantages of the presence of the adhesive agent 5 more significant. When the adhesive agent 5 content is too small, the advantages of the presence of the adhesive agent 5 are not sufficient. When the adhesive agent 5 content is too large, likewise, there cannot be a more significant improvement in the hold of the absorbent polymer 3.

Preferably, each chip 1 is one that is flexible and elongated (belt-shaped) as illustrated in FIG. 16. This makes the chips 1 deform easily. When these chips 1 (chip aggregate 10) are packed into the container 9, the chips 1 deform whatever the internal shape of the container 9 is, or displays compliance with the container shape, ensuring that the chip aggregate 10 is packed all together smoothly. The area of contact of the chip aggregate 10 as a whole with ink Q, moreover, is maximized, hence improved absorption performance (absorption properties) on absorbing ink Q.

The total length (longitudinal length) of the chip 1 is preferably 0.5 mm or more and 200 mm or less for example, more preferably 1 mm or more and 100 mm or less, even more preferably 2 mm or more and 30 mm or less, although depending partly on the shape and size of the container 9 (see FIG. 16).

Likewise, the width (transverse length) of the chip 1 is preferably 0.1 mm or more and 100 mm or less for example, more preferably 0.3 mm or more and 50 mm or less, even more preferably 1 mm or more and 20 mm or less, although depending partly on the shape and size of the container 9.

The aspect ratio, between the total length and the width, is preferably 1 or more and 200 or less, more preferably 1 or more and 30 or less. The thickness of the chip 1, too, is 0.05 m or more and 2 mm or less, more preferably 0.1 mm or more and 1 mm or less (see FIG. 16).

In such numerical ranges, the hold of the absorbent polymer 3 as well as the retention of ink Q and the delivery of the ink Q to the absorbent polymer 3 by the fiber are better, hence better ink Q absorption properties of the entire chip 1. The chip aggregate 10 as a whole, moreover, is easily deformable and therefore is superior in compliance with the shape of containers 9.

In addition, the chip aggregate 10 may include chips 1 differing in size and/or shape.

The chip aggregate 10, moreover, may include chips 1 that are equal in at least one of total length, width, aspect ratio, and thickness, or may include chips 1 differing in all of these.

Preferably, the amount of chips 1 whose maximum width is 3 mm or less in the chip aggregate 10 is 30% by weight or more and 90% by weight or less, more preferably 40% by weight or more and 80% by weight or less. This leads to more effective prevention of unevenness in ink absorption properties.

When the amount of chips 1 whose maximum width is 2 mm or less is too small, it is likely that gaps are created between the chips 1 when the chip aggregate 10 is packed into the container 9. Inside the container 9, therefore, the ink Q absorption properties may be uneven. When the amount of chips 1 whose maximum width is 2 mm or less is too large, it tends to be so difficult to create gaps between the chips 1 that the bulk density of the chip aggregate 10 is not easily adjustable.

Preferably, the chips 1 are in a regular shape. That is, the chips 1 are preferably ones cut into a regular shape, for example using a paper shredder. This makes it unlikely that the bulk density of the chip aggregate 10 is uneven, thereby helping prevent unevenness in ink Q absorption properties inside the container 9. Chips 1 cut into a regular shape help minimize the area of cross-sections. The use of such chips 1 therefore helps control the production of dust (scattering of the fiber and/or absorbent polymer) while ensuring adequate ink absorption properties.

A “regular shape” refers to, for example, a polygonal shape, such as rectangular, square, triangle, or pentagonal, or a shape like a circle or an oval. The chips 1 may have the same dimensions and may be in similar shapes. For example, rectangular chips 1 are deemed to have a regular shape even when they vary in the length of the sides, as long as they fit the definition of a rectangle (the same applies to the other shapes, too).

Preferably, the amount of such chips 1 having a regular shape is 30% by weight or more, more preferably 50% by weight or more, even more preferably 70% by weight or more of the chip aggregate 10 as a whole.

For the chips 1, furthermore, it may be that the chips 1 are in irregular shapes. This ensures that the chips 1 easily become entangled, thereby helping prevent the division or localization of the chip aggregate 10, it becomes easier to maintain the shape of the chip aggregate 10 as a whole. Chips 1 having irregular shapes, moreover, helps maximize the area of cross-sections (surfaces created by tearing), thereby helping further increase the area of contact with ink Q. The use of such chips 1 therefore contributes to quick absorption of ink Q.

An “irregular shape” refers to one that is not a “regular shape” as described above, such as the shape of roughly cut or hand-torn pieces (see FIG. 15).

The chip aggregate 10, furthermore, may be one in which such chips 1 having a regular shape and chips 1 having irregular shapes intermingle. This allows the chip aggregate 10 to share both of the advantages described above.

As mentioned above, each chip 1 is elongated one (has a longitudinal dimension). Inside the container 9, the chips 1 are loaded in such a manner that each of them extends in different directions. That is, multiple chips 1 are present irregularly but as an aggregate in the container 9 so that the directions in which the chips 1 extend are not aligned (not parallel) but cross together. In other words, the chips 1 are packed randomly (with or without order) in two-dimensional directions (e.g., the direction along the bottom 91) or three-dimensional directions (the three directions in the packing space 93) inside the container 9.

In such a packing state, it is likely that gaps are created between the chips 1. By virtue of this, ink Q can pass through the gaps and, when the gaps are microscopic, can spread by capillarity; that is, permeability to ink Q is guaranteed. This prevents the ink Q flowing downwards inside the container 9 from being interrupted, thereby allowing the ink Q to penetrate to the depths (bottom 91) of the container 9. This ensures equal absorption and long-term retention of the ink Q by the chips 1.

In addition, the chip aggregate 10 can change its shape freely. This means the desired amount (appropriate amount) of it can be packed into the container 9, and, for example, its bulk density is easily adjustable. As a result, unevenness in ink Q absorption properties is prevented.

The random packing of the chips 1 also increases the chance of contact of the chip aggregate 10 as a whole with ink Q; therefore, absorption performance on absorbing ink Q is improved. When the chip aggregate 10 is packed into a container 9, furthermore, the chips 1 can be put into the container 9 randomly; therefore, the packing work is easy and quick.

In addition, when the volume of the container 9 (packing space 93) is V1, and the total volume of the chip aggregate 10 that has yet to absorb ink Q (yet to absorb water) is V2, the ratio between V1 and V2, V2/V1, is preferably 0.1 or more and 0.7 or less, more preferably 0.2 or more and 0.7 or less (see FIG. 1). This creates a void 95 inside the container 9. The chips 1 expand (swell) after absorbing ink Q. The void 95 serves as a buffer when the chips 1 expand, thereby allowing the chips 1 to absorb sufficient ink Q.

Preferably, the bulk density of the chip aggregate 10 is 0.01 g/cm³ or more and 0.5 g/cm³ or less, more preferably 0.03 g/cm³ or more and 0.3 g/cm³ or less. Within these, it is particularly preferred that the bulk density of the chip aggregate 10 be 0.05 g/cm³ or more and 0.2 g/cm³ or less. This ensures good retention and permeation of ink Q.

When the bulk density of the chip aggregate 10 is too small, the absorbent polymer 3 content tends to be so low that the retention of ink Q can be insufficient. When the bulk density of the chip aggregate 10 is too large, the permeation of ink Q can be insufficient because the gaps between the chips 1 are not sufficient in such a case.

Being flexible and therefore deformable, furthermore, the chips 1 allow the manufacturer to adjust the bulk density of the chip aggregate 10 easily and properly, helping achieve such a bulk density as specified above.

Next, a method for producing the ink absorbing material 10 is described.

This production method has a placement step, a water supply step (adhesive agent supply step), and a heating and compression step.

First, as illustrated in FIG. 18, a sheet-shaped fibrous support 2, which has yet to be cut into chips 1, is mounted on a stage 300 (placement step).

Then a liquid adhesive agent 5 (e.g., water or a water-soluble adhesive agent) is supplied to one side of the sheet-shaped fibrous support 2 (water supply step or adhesive agent supply step). Examples of methods for this supplying task include spray coating as well as soaking a sponge roller in water, a water-soluble adhesive agent, etc., and then rolling the sponge roller on one side of the sheet-shaped fibrous support 2.

Then, as illustrated in FIG. 19, an absorbent polymer 3 is supplied to one side of the sheet-shaped fibrous support 2, with a mesh element 400 therebetween. The mesh element 400 has mesh openings 401; particles of the absorbent polymer 3 larger than the mesh openings 401 are trapped on the mesh element 400, and chips smaller than the mesh openings 401 pass through the mesh openings 401 and are supplied to one side of the sheet-shaped fibrous support 2.

In this way, the use of a mesh element 400 helps make the diameter of the particles of the absorbent polymer 3 as uniform as it can be. It therefore helps prevent absorbency from varying from point to point of the fibrous support 2.

Preferably, the maximum width of the mesh openings 401 is 0.06 mm or more and 0.15 mm or less, more preferably 0.08 mm or more and 0.12 mm or less. This ensures that the diameter of the particles of the absorbent polymer 3 supplied to the fibrous support 2 is in any of the numerical ranges specified above.

The shape of the mesh openings 401 is not critical; they can be in any shape, such as a triangle, a quadrangle, a polygon with five or more sides, a circle, or an oval.

Then, as illustrated in FIG. 20, the sheet-shaped fibrous support 2 with an attached absorbent polymer 3 is placed between a pair of heating blocks 500. Then the pair of heating blocks 500 are heated, and the fibrous support 2 is compressed in the direction of thickness by pressing the heating blocks 500 to bring them closer to each other (heating and compression step). This causes the absorbent polymer 3 containing water or (a water-soluble adhesive agent) to soften as a result of heating, and also to enter the inside of the fibrous support 2 as a result of compression. Stopping heating and compression makes the water (or water-soluble adhesive agent) dry and the absorbent polymer 3 become bonded to the fibrous support 2 while present inside the fibrous support 2, completing a state in which the absorbent polymer 3 is spread inside the fibrous support 2 (see FIG. 17).

Preferably, the compression force in this step is 0.1 kg/cm² or more and 1.0 kg/cm² or less, more preferably 0.2 kg/cm² or more and 0.8 kg/cm² or less. The heating temperature in this step is preferably 80° C. or more and 160° C. or less, more preferably 100° C. or more and 120° C. or less.

Then the sheet-shaped fibrous support 2 is finely shredded, coarsely milled, or pulverized, for example using scissors, a utility knife, a mill, or a paper shredder, or manually torn into small pieces, giving a chip aggregate 10 formed by chips 1.

Then the desired amount is weighed out of this chip aggregate 10 and packed into a container 9 after bulk density adjustment, for example by manual disentangling, to give an ink absorbing device 100.

An ink absorbing material 10 has been described up to this point. The ink absorbing device 100 and the printing apparatus 200 that include the ink absorbing material 10 are not described; they are the same as described in Embodiment 1 with reference to FIG. 1.

The ink absorbing material 10 is made with a chip aggregate 10. The chip aggregate 10 includes multiple chips 1 that are flexible, and, in this embodiment, is used with these chips 1 packed all together in a container 9. This makes the chip aggregate 10 an ink absorbing device 100. As mentioned above, the ink absorbing device 100 is attached to a printing apparatus 200 and in that state is capable of absorption of waste ink Q.

The number of chips 1 packed into the container 9 is not critical. For example, as many chips 1 as needed are selected according to the relevant conditions, such as the purpose of use of the ink absorbing device 100. The ink absorbing device 100 is therefore one that is simple in structure, as many chips 1 as needed packed in a container 9. The quantity of packed chips 1 determines the maximum amount of ink Q absorbed at the chip aggregate 10 (ink absorbing device 100).

### Embodiment 10

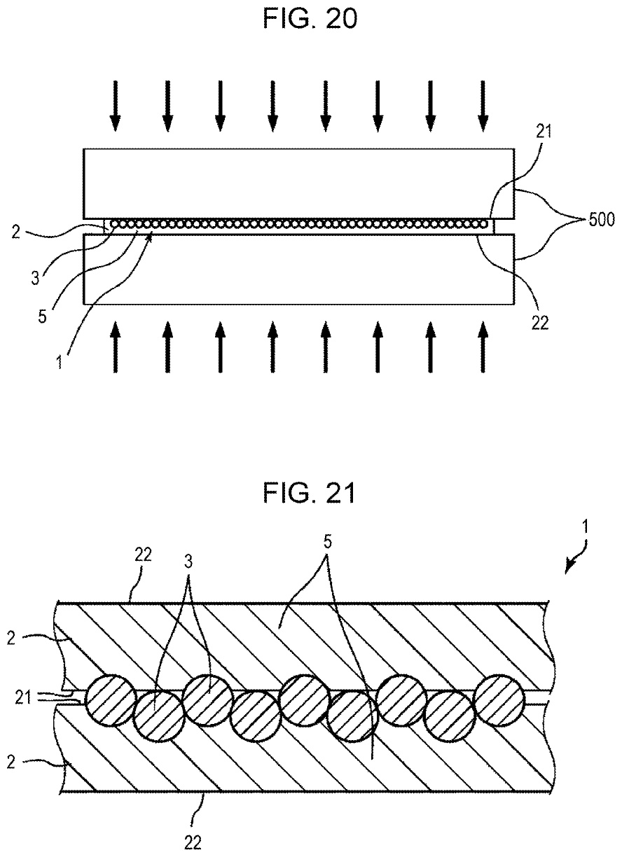

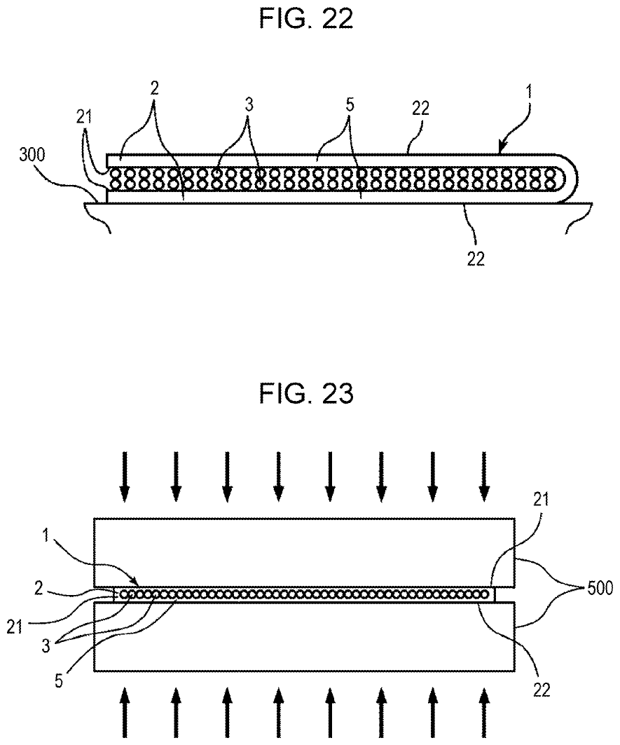

FIG. 21 is a cross-sectional view of a chip included in the ink absorbing device illustrated in FIG. 1. FIG. 22 is a diagram illustrating a production process for the production of the ink absorbing material illustrated in FIG. 21, illustrating a sheet-shaped fibrous support folded with water (or a water-soluble adhesive agent) and an absorbent polymer supplied thereto. FIG. 23 is a diagram illustrating a production process for the production of the ink absorbing material illustrated in FIG. 21, illustrating the heating and compression of a sheet-shaped fibrous support.

The following describes a chip aggregate and an ink absorbing device according to the present invention in Embodiment 10 with reference to these drawings. The following description, however, is centered on differences from the above embodiments, leaving out the description of similarities.

This embodiment is the same as Embodiment 9 above except that the structure of the chips inside the container is different.

As illustrated in FIG. 21, the chips 1 in this embodiment has a stack of multiple (in the illustrated structure, two) fibrous supports 2. The absorbent polymer 3 is between the fibrous supports 2. This is therefore a structure in which the absorbent polymer 3 is sandwiched between and covered with the fibrous supports 2. By virtue of this, it is even more unlikely that the absorbent polymer 3 detaches from the fibrous supports 2. As well as the ink absorbing material exhibits high ink absorption properties for a longer period of time, uneven distribution of the absorbent polymer 3 inside the container 9 is prevented more effectively; as a result, unevenness in ink Q absorption properties is prevented.

It should be noted that this embodiment is not limited to the illustrated structure. The chips 1 may have a structure in which three or more fibrous supports 2 are stacked.

Next, a method for producing the ink absorbing material 10 is described.

This production method has a placement step, a water supply step (adhesive agent supply step), a folding step, and a heating and compression step. The placement step and the water supply step (adhesive agent supply step) are not described; they are the same as in Embodiment 9 above.

As illustrated in FIG. 22, a sheet-shaped fibrous support 2 that has completed the placement step and the water supply step (adhesive agent supply step) is folded in half (folding step). The fibrous support 2 is folded in two in such a manner that the surface coated with the absorbent polymer 3 in a first half will come into contact with that in the second.

Then, as illustrated in FIG. 23, the folded sheet-shaped fibrous support 2 is placed between a pair of heating blocks 500. Then the pair of heating blocks 500 are heated, and the fibrous support 2 is compressed in the direction of thickness by pressing the heating blocks 500 to bring them closer to each other (heating and compression step). This causes the absorbent polymer 3 containing water or (a water-soluble adhesive agent) to soften as a result of heating, and also to enter the inside of the fibrous support 2 as a result of compression. The particles of the absorbent polymer 3 laid on one another as a result of folding also soften and become bonded together.

Stopping heating and compression makes the water (or water-soluble adhesive agent) dry and the absorbent polymer 3 become bonded to the fibrous support 2 while present inside the fibrous support 2, completing a state in which the absorbent polymer 3 is spread inside the fibrous support 2. The portions of the fibrous support 2 stacked as a result of folding are also bonded together by the absorbent polymer 3 and water (or water-soluble adhesive agent).

Then the sheet-shaped fibrous support 2 is finely shredded, coarsely milled, or pulverized, for example using scissors, a utility knife, a mill, or a paper shredder, or manually torn into small pieces, giving a chip aggregate 10 formed by chips 1.

Then the desired amount is weighed out of this chip aggregate 10 and packed into a container 9 after bulk density adjustment, for example by manual disentangling, to give an ink absorbing device 100.

In such a production method, the structure of stacked fibrous supports 2 can be produced easily by folding one fibrous support 2 coated with an absorbent polymer 3 and an adhesive agent 5 (water or a water-soluble adhesive agent), or without the work of coating each of two fibrous supports 2 with an absorbent polymer 3 and an adhesive agent 5 (water or a water-soluble adhesive agent). The production process is therefore simple.

In the heating and compression step, furthermore, the heating blocks 500 come into contact with the surface of the fibrous support 2 with no adhering absorbent polymer 3; therefore, the adhesion of the absorbent polymer 3 to the heating blocks 500 is prevented. Requiring no step of washing the heating blocks 500, this production method is superior in productivity.

The foregoing description of ink absorbing materials, ink absorbing devices, and droplet ejecting apparatuses according to the present invention in illustrated embodiments does not mean the present invention is limited to it. Each structural element of the chip aggregates and the ink absorbing devices can be replaced with one having any other configuration that provides the same function. There may be any component added to it.

An ink absorbing material, an ink absorbing device, and a droplet ejecting apparatus according to the present invention, furthermore, may be combinations of any two or more configurations (features) in the above embodiments.

In addition, the use of the ink absorbing devices according to the present invention in the above embodiments is a “waste liquid tank (waste ink tank), but this is not the only possible option. For example, it may be a “receiver for ink leakages” that absorbs ink that has accidentally leaked out of an ink channel of a printing apparatus.

### EXAMPLES

Next, specific examples of the present invention are described.

### Example 1

### [1] Production of an Ink Absorbing Material

First, a sheet of waste paper measuring 30 cm long, 22 cm wide, and 0.5 mm thick (A4 sheet-shaped fibrous support) was prepared. The average length, average width, and aspect ratio (average length/average width) of the fiber threads contained in this sheet of waste paper were 0.71 mm, 0.2 mm, and 3.56, respectively. The weight of the waste paper was 4 g/sheet.

Then one side of this sheet of waste paper was sprayed with a small amount of water using a spray bottle.

Then SANFRESH 500MPSA (Sanyo Chemical Industries) as a crosslinked polyacrylic-acid polymer (partially sodium polyacrylate crosslinked compound), which is an absorbent polymer having a pendant carboxyl group as an acid group, was supplied to the water-sprayed side of the sheet of waste paper. While being supplied, the absorbent polymer was screened through a sieve having a mesh with an opening of 0.106 mm (JTS-200-45-106, Tokyo Screen Co., Ltd.) (see FIG. 19). The amount of absorbent polymer applied was 4 g.

Then the sheet of waste paper (sheet-shaped fibrous support) was folded in half to make a valley fold on the side with adhering absorbent polymer. In this folded state (A5 size), the sheet-shaped fibrous support was compressed in the thickness of direction and heated using a pair of heating blocks such as illustrated in FIG. 20. The compression was at 0.3 kg/cm², and the heating temperature was 100° C. The duration of heating and compression was 2 minutes.

Then heating and compression was stopped, and, after the sheet-shaped fibrous support returned to room temperature, the sheet-shaped fibrous support was cut into chips measuring 2 mm×15 mm. The absorbent polymer content of the chips was 50% by weight, and the average diameter of the particles of the absorbent polymer was between 35 and 50 μm. The average length of fiber threads was 25 mm, and the average width of the fibrous support was 10 mm. In each chip, the absorbent polymer had spread inside (was implanted in) the fibrous support.

### Examples 2 and 3

An ink absorbing material was produced in the same way as in Example 1 above except that chip parameters were changed as presented in Table 1.

### Example 4

### [1] Production of an Ink Absorbing Material

First, a sheet of waste paper measuring 30 cm long, 22 cm wide, and 0.5 mm thick (A4 sheet-shaped fibrous support) was prepared. The average length, average width, and aspect ratio (average length/average width) of the fiber threads contained in this sheet of waste paper were 0.71 mm, 0.2 mm, and 3.56, respectively. The weight of the waste paper was 4 g/sheet.

Then the entire surface of this sheet of waste paper was coated, by spraying from one side, with 100 g of an aqueous solution of liquid polyvinyl alcohol (95 g of water and 5 g of polyvinyl alcohol) as a water-soluble adhesive agent (see FIG. 18).

Then, SANFRESH 500MPSA (Sanyo Chemical Industries) as a crosslinked polyacrylic-acid polymer (partially sodium polyacrylate crosslinked compound), which is an absorbent polymer having a pendant carboxyl group as an acid group, was supplied to the side of the sheet of waste paper sprayed with the water-soluble adhesive agent. While being supplied, the absorbent polymer was screened through a sieve having a mesh with an opening of 0.106 mm (JTS-200-45-106, Tokyo Screen Co., Ltd.) (see FIG. 19). The amount of absorbent polymer applied was 4 g.

Then the sheet of waste paper (sheet-shaped fibrous support) was folded in half to make a valley fold on the side with adhering absorbent polymer. In this folded state (A5 size), the sheet-shaped fibrous support was compressed in the thickness of direction and heated using a pair of heating blocks such as illustrated in FIG. 20. The compression was at 0.3 kg/cm², and the heating temperature was 100° C. The duration of heating and compression was 2 minutes.

Then heating and compression was stopped, and, after the sheet-shaped fibrous support returned to room temperature, the sheet-shaped fibrous support was pulverized in a mill for 60 seconds. In Example 4, the resulting powder contained fibrils (flocs) and irregularly shaped chips. The absorbent polymer content of the chips (fiber and absorbent polymer) was 50% by weight, and the average diameter of the particles of the absorbent polymer was between 35 and 50 μm. The water-soluble adhesive agent content of the chips was 2.5% by weight of the fiber. In each chip, the absorbent polymer had spread inside (was implanted in) the fibrous support.

### Examples 5 to 7

An ink absorbing material was produced in the same way as in Example 1 above except that chip parameters were changed as presented in Table 1.

It should be noted that Examples 1 to 3 and 5 to 7 have a regular shape (rectangular), and Example 4 is in irregular shapes.

### [2] Testing

### [2-1] Absorption Properties (2 Minutes)

First, AS ONE Corporation's New Disposable Cup 100 mL plastic containers were prepared. The ink absorbing materials produced in Examples above, 2.0 g each, were put into separate containers to the bulk density presented in Table 1. The ink absorbing materials in the containers were checked, finding almost no absorbent polymer had detached.

Then 25 cc of a commercially available ink jet ink (ICBK-61, Seiko Epson Corporation) was poured into the containers with encased ink absorbing materials therein. Two minutes after all ink was poured, the inside of the containers was visually inspected. The condition was graded according to the following criteria.

A: There is no ink bleed on the surface of the ink absorbing material.

B: Ink bleeds are found on part of the surface of the ink absorbing material, but no ink pool is observed; almost all ink has been absorbed.

C: Ink bleeds are found on part of the surface of the ink absorbing material, and some ink pools are observed.

D: Ink pools are observed on the surface of the ink absorbing material.

### [2-2] Absorption Properties (5 Minutes)

First, AS ONE Corporation's New Disposable Cup 100 mL plastic containers were prepared. The ink absorbing materials produced in Examples above, 2.0 g each, were put into separate containers to the bulk density presented in Table 1.

Then 25 cc of a commercially available ink jet ink (ICBK-61, Seiko Epson Corporation) was poured into the containers with encased ink absorbing materials therein. Five minutes after all ink was poured, the inside of the containers was visually inspected. The condition was graded according to the following criteria.

A: There is no ink bleed on the surface of the ink absorbing material.

B: Ink bleeds are found on part of the surface of the ink absorbing material, but no ink pool is observed; almost all ink has been absorbed.

C: Ink bleeds are found on part of the surface of the ink absorbing material, and some ink pools are observed.

D: Ink pools are observed on the surface of the ink absorbing material.

### [2-3] Absorption Properties (30 Minutes)

First, AS ONE Corporation's New Disposable Cup 100 mL plastic containers were prepared. The ink absorbing materials produced in Examples above, 2.0 g each, were put into separate containers to the bulk density presented in Table 1.

Then 25 cc of a commercially available ink jet ink (ICBK-61, Seiko Epson Corporation) was poured into the containers with encased ink absorbing materials therein. Thirty minutes after all ink was poured, the inside of the containers was visually inspected. The condition was graded according to the following criteria.

A: There is no ink bleed on the surface of the ink absorbing material.

B: Ink bleeds are found on part of the surface of the ink absorbing material, but no ink pool is observed; almost all ink has been absorbed.

C: Ink bleeds are found on part of the surface of the ink absorbing material, and some ink pools are observed.

D: Ink pools are observed on the surface of the ink absorbing material.

TABLE 1

| | | | | | Water- | | | | |
|---|---|---|---|---|---|---|---|---|---|
| | | | | | soluble | | | | |
| | Absorbent polymer | | | | adhesive | | | | |
| | Average | | Fibrous support | | agent | | Testing | | |
| | particle | Amount | Average | Average | Percentage | Bulk | Absorption | Absorption | Absorption |
| | diameter | [% by | length | width | [% by | density | properties | properties | properties |
| | [μm] | weight] | [mm] | [mm] | weight] | [g/cm³] | (2 minutes) | (5 minutes) | (30 minutes) |
| Example | 35 to 50 | 50 | 25 | 10 | — | 0.2 | D | D | D |
| 1 | | | | | | | | | |
| Example | 35 to 50 | 50 | 25 | 5 | — | 0.2 | D | D | D |
| 2 | | | | | | | | | |
| Example | 35 to 50 | 50 | 25 | 2.5 | — | 0.2 | D | D | D |
| 3 | | | | | | | | | |
| Example | 35 to 50 | 50 | Random, ranging from | Same as | 2.5 | 0.05 | A | A | A |
| 4 | | | flocculent fibrils to | on the left | | | | | |
| | | | about 5-mm squares | | | | | | |
| Example | 35 to 50 | 50 | 25 | 2 | — | 0.07 | C | C | C |
| 5 | | | | | | | | | |
| Example | 35 to 50 | 50 | 3 | 2 | — | 0.2 | D | D | A |
| 6 | | | | | | | | | |
| Example | 35 to 50 | 50 | 15 | 2 | — | 0.08 | C | B | A |
| 7 | | | | | | | | | |

As is clear from Table 1, Examples of the present invention demonstrated superior absorption properties.

Although not presented in the table, the ink absorbing materials in Examples 1 to 7 were observed in the containers at 24 hours in the same way as in [2-1] to [2-3] with the result that there was no ink bleed on the surface of the ink absorbing material (grade A). That is, the ink absorbing materials in Examples 1 to 7 were superior in ink absorption properties and fall within the scope of application of the present invention.

Then the testing for the materials' anti-leakage effect was repeated in the same way except that Seiko Epson's ink jet ink (ICBK80) was replaced with Canon's ink jet ink (BCI-381sBK), Brother's ink jet ink (LC3111BK), and Hewlett-Packard's ink jet ink (HP 61XL CH563WA). The results were the same.

Then the testing for the materials' anti-leakage effect was further repeated in the same way except that various changes were made to the volume and shape of the container and the amount of ink supplied. The results were the same.

10 . . . chip aggregate (ink absorbing material), 1 . . . chip, 1A . . . first chip group, 1B . . . second chip group, 11 . . . bend (fold), 12 . . . folded portion, 2 . . . fibrous support, 21 . . . front surface, 22 . . . back surface, 3 . . . absorbent polymer, 4 . . . connector, 5 . . . adhesive agent (water or a water-soluble adhesive agent), 8 . . . lid, 81 . . . connection opening, 82 . . . lower surface (back surface), 9 . . . container, 91 . . . bottom (bottom plate), 92 . . . side wall, 921 . . . protrusion, 93 . . . packing space, 94 . . . upper opening, 95 . . . void, 96 . . . top surface, 97 . . . connection port, 20 . . . gap, 100 . . . ink absorbing device, 200 . . . printing apparatus, 201 . . . ink-ejecting head, 201a . . . nozzle, 202 . . . capping unit, 203 . . . tube, 203a . . . outlet (opening), 204 . . . roller pump, 204a . . . roller section, 204b . . . holding section, L₁ . . . total length (longitudinal length), Q . . . ink, t₁ . . . thickness, W₁ . . . width (transverse length), V1 . . . volume, V2 . . . total volume, 300 . . . stage, 400 . . . mesh element, 401 . . . mesh openings, 500 . . . heating block

### TECHNICAL FIELD

The present invention relates to an ink absorbing material, an ink absorbing device, and a droplet ejecting apparatus.

### BACKGROUND ART

Ink jet printers usually produce waste ink during a head cleaning operation, which is performed to prevent low print quality due to clogging with ink, and an ink loading operation after the replacement of ink cartridge(s). To prevent accidental adhesion of such waste ink, for example to internal mechanisms, ink jet printers are equipped with a liquid absorber that absorbs waste ink (ink absorber).

In the related art, the liquid absorber (ink absorber) has been one that contains natural cellulose fiber and/or a synthetic fiber and a heat-fusible substance (e.g., see PTL 1).

Alternatively, the liquid absorber has been one that contains a hydrophilic fiber and a highly absorbent polymer (e.g., see PTL 2).

With the known liquid absorbers (ink absorbers), however, waste ink cannot be absorbed quickly because of their poor permeability to ink. The absorbed ink, moreover, can accidentally leak depending on the amount of ink absorbed.

The liquid absorber according to PTL 2, furthermore, is shaped like a block as a whole. This liquid absorber is therefore not compliant with the shape of its container, making it difficult to adjust its amount and density in its container. Another disadvantage of the liquid absorber according to PTL 2 is that the highly absorbent polymer can detach from the hydrophilic fiber, for example because of an external impact. This can cause uneven ink absorption properties as a result of separation between the hydrophilic fiber and the highly absorbent polymer in the container.

### CITATION LIST

### Patent Literature

PTL 1: Japanese Patent No. 3536870

PTL 2: Japanese Unexamined Patent Application Publication No. 4-90851

### SUMMARY OF INVENTION

### Technical Problem

An object of the present invention is to provide an ink absorbing material that offers improved ink absorption properties and the prevention of leakages of absorbed ink, to provide an ink absorbing device, and to provide a droplet ejecting apparatus.

An object of the present invention, furthermore, is to provide an ink absorbing material the desired amount (appropriate amount) of which can be packed into a container with reduced occurrence of uneven ink absorption properties, to provide an ink absorbing device, and to provide a droplet ejecting apparatus.

### Solution to Problem

The present invention was made to solve at least part of the above problem and can be implemented as follows.

An ink absorbing material according to the present invention is a chip aggregate that includes multiple chips each having a fiber-containing fibrous support and an absorbent polymer held by the fibrous support.

This ensures that when ink is supplied to the chip aggregate, the chance of contact with the ink and the area of contact with the ink are maximized. The fiber (fibrous support), furthermore, retains the ink temporarily. The ink can then be sent from the fiber to the absorbent polymer more efficiently, hence improved ink absorption properties of the chip aggregate as a whole. In addition, the chip aggregate provides long-term retention of absorbed ink; this helps prevent the ink from leaking.

In the ink absorbing material according to the present invention, each of the chips forming the chip aggregate preferably has the absorbent polymer on at least one side of the fibrous support, with the absorbent polymer adhering to the fibrous support.

This makes the absorbent polymer exposed on the fibrous support. With this absorbent polymer, therefore, ink can be absorbed quickly.

In the ink absorbing material according to the present invention, each of the chips forming the chip aggregate preferably has the absorbent polymer somewhere in a thickness dimension of the fibrous support.

This ensures that ink is retained (absorbed) as deep inside the sheets as it can be, or as close to the middle of the sheets in the direction of their thickness as it can be, hence extended retention of the ink.

In the ink absorbing material according to the present invention, each of the chips is preferably elongated one.

This makes the chips deform easily. When these chips (chip aggregate) are packed into a container, therefore, the chips deform whatever the internal shape of the container is, or displays shape compliance; as a result, the chip aggregate is packed all together smoothly.

In the ink absorbing material according to the present invention, there is preferably a connector that connects part of each of the elongated chips together.

This ensures that when the chip aggregate is packed into a container, multiple chips can be put into the container by holding the connector and casting it together with the connected chips; as a result, the packing work is easy and quick.

In the ink absorbing material according to the present invention, the absorbent polymer preferably contains a crosslinked polyacrylic-acid polymer.

This brings advantages such as improved performance on absorbing ink and the possibility of reduced production cost.

An ink absorbing device according to the present invention is an ink absorbing device that includes the ink absorbing material according to the present invention and a container in which the ink absorbing material is encased.

Each of the chips is elongated, and the ink absorbing material is encased in the container in such a manner that each of the chips extends in a direction that crosses a direction in which another extends inside the container.

This creates gaps between the chips. By virtue of this, ink can pass through the gaps and, when the gaps are microscopic, can spread by capillarity; that is, permeability to ink is guaranteed. The ink is therefore prevented from being interrupted, hence equal absorption and long-term retention by the chips.

An ink absorbing device according to the present invention is an ink absorbing device that includes the ink absorbing material according to the present invention and a container in which the ink absorbing material is encased.

Each of the chips is elongated, and the ink absorbing material is encased in the container in such a manner that each of the chips extends in the same direction inside the container.

This is effective, for example when ink flows down inside the chip aggregate and the user wants to reduce its downflow speed (penetration speed).

An ink absorbing device according to the present invention is an ink absorbing device that includes the ink absorbing material according to the present invention and a container in which the ink absorbing material is encased.

Each of the chips is elongated, and the ink absorbing material is encased in the container with the chips folded inside the container.

This ensures that when the chip aggregate is packed into the container, the chip aggregate can be packed into the container easily, although depending partly on the internal shape of the container. The chip aggregate, furthermore, then remains stably packed.

A droplet ejecting apparatus according to the present invention includes the ink absorbing device according to the present invention. The ink absorbing device is used to absorb waste ink.

This makes it possible to use an ink absorbing device as a so-called “waste liquid tank (waste ink tank)” of a droplet ejecting apparatus. After the amount of ink absorbed by the ink absorbing device reaches its limit, furthermore, this ink absorbing device can be replaced with a new (unused) ink absorbing device.

An ink absorbing material according to the present invention is a chip aggregate that includes multiple chips each having a fiber-containing fibrous support and an absorbent polymer at least part of which is spread inside the fibrous support.

An ink absorbing device according to the present invention includes the ink absorbing material according to the present invention and

a container into which the ink absorbing material is packed.

A droplet ejecting apparatus according to the present invention includes the above ink absorbing device. The ink absorbing device is used to absorb waste ink.

### BRIEF DESCRIPTION OF DRAWINGS

FIG. 1 is a partial vertical cross-sectional diagram illustrating an example of an ink absorbing device according to the present invention in use.

FIG. 2 is a perspective view of a chip as a member of the chip aggregate included in the ink absorbing device illustrated in FIG. 1.

FIG. 3 is a cross-sectional view along line A-A in FIG. 2.

FIG. 4 is an exploded perspective diagram illustrating the relative positions of chip aggregates to be packed in an ink absorbing device according to the present invention.

FIG. 5 is an exploded perspective diagram illustrating the relative positions of chip aggregates to be packed in an ink absorbing device according to the present invention.

FIG. 6 is a plan view of a chip aggregate to be packed in an ink absorbing device according to the present invention.

FIG. 7 is a plan diagram illustrating the chip aggregate of FIG. 6 in a container.

FIG. 8 is a cross-sectional view along line B-B in FIG. 7.

FIG. 9 is a cross-sectional view along line C-C in FIG. 7.

FIG. 10 is a vertical cross-sectional diagram illustrating a variation of chip aggregates packed in an ink absorbing device according to the present invention.

FIG. 11 is a perspective view of a chip as a member of a chip aggregate included in an ink absorbing device according to the present invention.

FIG. 12 is a perspective view of a chip as a member of a chip aggregate included in an ink absorbing device according to the present invention.

FIG. 13 is a vertical cross-sectional view of a chip as a member of a chip aggregate included in an ink absorbing device according to the present invention.

FIG. 14 is a perspective diagram illustrating an ink absorbing device according to the present invention.

FIG. 15 is a perspective diagram illustrating an exemplary form of an ink absorbing material according to the present invention.

FIG. 16 is a perspective diagram illustrating an exemplary form of an ink absorbing material according to the present invention.

FIG. 17 is a cross-sectional view of a chip included in an ink absorbing material according to the present invention.

FIG. 18 is a diagram illustrating a production process for the production of an ink absorbing material according to the present invention, illustrating the application of a water-soluble adhesive agent.

FIG. 19 is a diagram illustrating a production process for the production of an ink absorbing material according to the present invention, illustrating the supply of an absorbent polymer.

FIG. 20 is a diagram illustrating a production process for the production of an ink absorbing material according to the present invention, illustrating the heating and compression of a sheet-shaped fibrous support.

FIG. 21 is a cross-sectional view of a chip included in the ink absorbing device illustrated in FIG. 1.

FIG. 22 is a diagram illustrating a production process for the production of the ink absorbing material illustrated in FIG. 21, illustrating a sheet-shaped fibrous support folded with a water-soluble adhesive agent and an absorbent polymer supplied thereto.

FIG. 23 is a diagram illustrating a production process for the production of the ink absorbing material illustrated in FIG. 21, illustrating the heating and compression of a sheet-shaped fibrous support.

### DESCRIPTION OF EMBODIMENTS

The following describes the details of an ink absorbing material, an ink absorbing device, and a droplet ejecting apparatus according to the present invention based on their preferred embodiments illustrated in attached drawings.

### Embodiment 1

FIG. 1 is a partial vertical cross-sectional diagram illustrating an example of an ink absorbing device according to the present invention (Embodiment 1) in use. FIG. 2 is a perspective view of a chip as a member of the chip aggregate included in the ink absorbing device illustrated in FIG. 1. FIG. 3 is a cross-sectional view along line A-A in FIG. 2. In the following, words such as up, down, top, bottom, above, below, upwards, downwards, etc., are based on the vertical directions in FIGS. 1 to 3 (FIGS. 8 and 9) for the sake of description.

As illustrated in FIG. 1, an ink absorbing material according to the present invention is a chip aggregate 10. The chip aggregate 10 includes multiple chips 1 each of which is used to absorb ink Q. A chip 1 has a fiber-containing fibrous support 2 and an absorbent polymer 3 held on the fibrous support 2 (see FIG. 3).

An ink absorbing device 100 according to the present invention includes a chip aggregate 10 that is an ink absorbing material and a container 9 in which the chip aggregate 10 is packed (see FIG. 1).

This ensures that when ink Q is supplied to the chip aggregate 10, the chance of contact with the ink Q and the area of contact with the ink Q are maximized, compared with the case in which a one-piece (a sheet of) fibrous support 2 or a stack of one-piece fibrous supports 2 (sheets of material) is used as an ink absorber. The fiber (fibrous support 2), furthermore, retains the ink Q temporarily. The ink Q is then sent from the fiber to the absorbent polymer 3 more efficiently, hence improved ink Q absorption properties of the chip aggregate 10 as a whole. In addition, the chip aggregate 10 provides long-term retention of absorbed ink Q; this helps prevent the ink Q from leaking out of the ink absorber 100.

It should be noted that “absorbent” as mentioned herein naturally means that the polymer absorbs water-based inks, which are solutions of colorant(s) in an aqueous medium or media, but also embraces the ability of the polymer to absorb inks in general, including solvent-based inks, which are solutions of binder(s) in solvent(s), UV-curable inks, which are solutions of binder(s) in liquid monomer(s) that cures in response to UV irradiation, and latex inks, which are dispersions of binder(s) in a dispersion medium or media.

The printing apparatus (droplet ejecting apparatus) 200 illustrated in FIG. 1 is, for example, an ink jet color printer. This printing apparatus 200 includes an ink-ejecting head 201 that ejects ink Q, a capping unit 202 that prevents the clogging of the nozzles 201a of the ink-ejecting head 201, a tube 203 that connects the capping unit 202 and the ink absorbing device 100 together, and a roller pump 204 that sends the ink Q from the capping unit 202 to the ink absorbing device 100.

The ink-ejecting head 201 has multiple nozzles 201a each of which ejects ink Q downwards. This ink-ejecting head 201 produces a print by ejecting ink Q while moving relative to a recording medium, such as a PPC sheet (not illustrated) (see the ink-ejecting head 201 drawn with long-dash double-short-dash lines in FIG. 1).

The capping unit 202 is a component that prevents the clogging of the nozzles 201a by draining all nozzles 201a at once through the operation of the roller pump 204 while the ink-ejecting head 201 is in its standby position.

The tube 203 is a passage for the ink Q sucked there by the action of the capping unit 202 to move toward the ink absorbing device 100. This tube 203 is flexible.

The roller pump 204, positioned somewhere along the tube 203, has a roller section 204a and a holding section 204b that holds somewhere of the tube 203 together with the roller section 204a. A rotation of the roller section 204a generates suction in the capping unit 202 via the tube 203. As the roller section 204a continues to rotate, therefore, the ink Q sticking to the nozzles 201a is sent into the ink absorbing device 100. This ink Q is absorbed as waste liquid at the chip aggregate 10 (ink absorbing material) inside the ink absorbing device 100. The ink Q contains inks in different colors.

As illustrated in FIG. 1, the ink absorbing device 100 includes a chip aggregate 10 that includes multiple (many) shredded chips 1, a container 9 in which the chip aggregate 10 is packed, and a lid 8 that seals the container 9.

This ink absorbing device 100 is detachably attached to the printing apparatus 200 and is used to absorb waste ink Q as described above while attached. This makes it possible to use an ink absorbing device 100 as a so-called “waste liquid tank (waste ink tank).” After the amount of ink Q absorbed by the ink absorbing device 100 reaches its limit, furthermore, this ink absorbing device 100 can be replaced with a new (unused) ink absorbing device 100. Whether the amount of ink Q absorbed by an ink absorbing device 100 has reached its limit is detected by a detector (not illustrated) placed inside the printing apparatus 200. When the amount of ink Q absorbed by an ink absorbing device 100 reaches its limit, the user is informed by an informing section, such as a built-in monitor of the printing apparatus 200.

The container 9 is a component in which the chip aggregate 10 is packed. This container 9 is one shaped like a box, having a bottom (bottom plate) 91 that is, for example, rectangular in plan view and four side walls 92 standing upright along the sides (edges) of the bottom 91. A packing space 93 enclosed by the bottom 91 and four side walls 92 can accommodate the chip aggregate 10.

The container 9 does not need to be one having a bottom 91 that is rectangular in plan view, but may be, for example, one having a bottom 91 that is round in plan view and therefore is cylindrical as a whole.

The container 9 is a rigid one. In other words, the container 9 is one that has shape retainability high enough that it does not change its volume V1 by 10% or more when internal pressure or an external force acts thereon.

This ensures that the container 9 maintains its own shape even when the chips 1 forming the chip aggregate 10 expand by absorbing ink Q and apply force to the container 9 from inside. By virtue of this, the container 9 stays in a stable position inside the printing apparatus 200, allowing the chips 1 to absorb ink Q consistently.

The container 9 can be made of any material as long as it is made of a material impermeable to ink Q. Examples of such materials that can be used for the container 9 include resin materials, such as cyclic polyolefins and polycarbonate. Besides resin materials, metallic materials, such as aluminum and stainless steel, can also be used as materials for the container 9.

The container 9, moreover, may be a transparent (or translucent) container that one can see through or a nontransparent container.

As mentioned above, the ink absorbing device 100 includes a lid 8 that seals the container 9. As illustrated in FIG. 1, the lid 8 is shaped like a plate and engages with an upper opening 94 of the container 9. The engagement provides a liquid-tight seal of the upper opening 94. This ensures, for example, that even when ink Q that falls down after being discharged from the tube 203 splashes up by hitting the chip aggregate 10 (chips 1), the ink Q is prevented from scattering out. This helps prevent ink Q from sticking around the ink absorbing device 100 and staining there.

In the middle of the lid 8 is a connection opening 81 to which the tube 203 is connected. The connection opening 81 is a through hole that penetrates through the thickness of the lid 8. To this connection opening 81 (through hole), the downstream end (lower end) of the tube 203 can be connected by inserting it there. The outlet (opening) 203a of the tube 203 in this state faces downwards.

On the lower surface (back surface) 82 of the lid 8, there may be, for example, radial ribs or grooves around the connection opening 81. The ribs or grooves serve as, for example, a rectifier (guide) that determines the direction in which ink Q should flow inside the container 9.

The lid 8, furthermore, may have absorbency, or absorb ink Q, or may have repellency, or repel ink Q.

The thickness of the lid 8 is not critical. For example, it is preferred that the thickness of the lid 8 be 1 mm or more and 20 mm or less, more preferably 8 mm or more and 10 mm or less. The lid 8 does not need to be a plate-shaped one that falls within such numerical ranges, but may be a thinner, filmy (sheet-shaped) one. In that case, too, the thickness of the lid 8 is not critical. For example, it is preferred that the thickness of the lid 8 be 10 μm or more and less than 1 mm.

As illustrated in FIG. 1, the chip aggregate 10 includes multiple chips 1 that are flexible, and, in this embodiment, is used with these chips 1 packed all together in a container 9. This makes the chip aggregate 10 an ink absorbing device 100. As mentioned above, the ink absorbing device 100 is attached to a printing apparatus 200 and in that state is capable of absorbing waste ink Q.

The number of chips 1 forming the chip aggregate 10, or packed in the container 9, is not critical. For example, as many chips 1 as needed are selected according to the relevant conditions, such as the purpose of use of the ink absorbing device 100. The ink absorbing device 100 is therefore one that is simple in structure, as many chips 1 as needed packed in a container 9. The quantity of packed chips 1 determines the maximum amount of ink Q absorbed at the chip aggregate 10 (ink absorbing device 100).

Each chip 1 has the same structure. In the following, therefore, one chip 1 is described as a representative example.

As mentioned above, a chip 1 has a fiber-containing fibrous support 2 and an absorbent polymer 3 held on the fibrous support 2. In this embodiment, as illustrated in FIG. 3, the fibrous support 2 as a component of the chip 1 is a finely shredded, coarsely milled, or powdered piece of a sheet of paper, such as waste paper, for example made using scissors, a utility knife, a mill, or a paper shredder. The absorbent polymer 3 is adhering to at least one side of the fibrous support 2 (in the structure illustrated in FIG. 3, the front surface 21 and the back surface 22). This ensures that the absorbent polymer 3 absorbs ink Q, whichever side of the chip 1, the front surface 21 or back surface 22 side, the ink Q reaches. The absorbent polymer 3, furthermore, is exposed on the fibrous support 2. With this absorbent polymer 3, therefore, ink Q can be absorbed quickly.

For the absorbent polymer 3, the amount of adhering absorbent polymer 3 is preferably equal between the front surface 21 and back surface 22 sides, but may be different.

The absorbent polymer 3, moreover, is preferably arranged and dispersed evenly on both of the front surface 21 and back surface 22 sides, but the degree of dispersion may be sparse in some areas and dense in others.

More preferably, the degree of dispersion of the absorbent polymer 3 on the front surface 21 side and that on the back surface 22 side are equal. However, the degree of dispersion of the absorbent polymer 3 may be different between the two sides.

How to hold the absorbent polymer 3 on (attach the polymer to) the fibrous support 2 is not critical. An example is to apply water, PVA, or glue and hold the polymer therewith. How much absorbent polymer 3 should be held on the fibrous support 2 is not critical either. For example, when the weight of the fibrous support 2 exceeds 0 g and 0.24 g, it is preferred that the weight of the absorbent polymer 3 be set to be 0.04 g or more and 0.12 g or less as necessary.

By virtue of the fibrous support 2, the absorbent polymer 3 is held well, and the detachment of the absorbent polymer 3 from the fibrous support 2 is prevented better. When ink Q is supplied to the chip 1, moreover, the fiber (fibrous support 2) retains the ink Q temporarily. The ink Q is then sent to the absorbent polymer 3 more efficiently, hence improved ink Q absorption properties of the entire chip 1. In general, furthermore, fibers such as cellulose fiber (in particular, fiber recycled from waste paper) are low-priced compared with absorbent polymers 3, which makes fibers also advantageous in terms of reducing the cost of producing the chips 1. Given that fiber recycled from waste paper is suitable for use, the use of fiber is also advantageous in terms of waste minimization, effective use of resources, etc.

Examples of fibers include synthetic resin fibers, such as polyester fiber and polyamide fiber; and natural resin fibers, such as cellulose fiber, keratin fiber, and fibroin fiber, and their chemically modified versions. Such fibers can be used alone or optionally blended, but it is preferred that the fiber be primarily cellulose fiber. It is more preferred that substantially all the fiber be cellulose fiber.

Cellulose is a material of good hydrophilicity, and, when ink Q is supplied to the chip 1, it allows the chip 1 to trap the ink Q well. The ink Q therefore quickly escapes a state of being extremely fluidic (e.g., a state in which its viscosity is 10 mPa·s or less), and the chip 1 sends the temporarily trapped ink Q to the absorbent polymer 3 well. As a result, the ink Q absorption properties of the entire chip 1 are superb. By virtue of the high compatibility of cellulose with absorbent polymers 3 in general, moreover, the absorbent polymer 3 is held on the surface of the fiber better. In addition, being a renewable natural material and low-priced and readily available even when compared with other fibers, cellulose fiber is also advantageous in terms of reducing the cost of producing the chips 1, stable production of the chips 1, reducing environmental burdens, etc.

As mentioned herein, cellulose fiber only needs to be a fibrous material that is primarily the compound cellulose (cellulose in a narrow sense). Cellulose fiber may therefore be one that contains hemicelluloses and/or lignins besides cellulose (cellulose in a narrow sense).

In the fibrous support 2 (chip 1), multiple fiber threads, for example, may be present independently of each other. In the fibrous support 2, moreover, the fiber may be contained in, for example, flocculent form. The fiber may be one that has been shaped like, for example, strips or chips.

The raw material for the fiber may be, for example, waste paper. This brings such advantages as mentioned above and is also preferred in terms of saving resources. When the raw material for the fiber is waste paper, the fiber is finely shredded, coarsely milled, or powdered pieces of the waste paper, for example made using scissors, a utility knife, a mill, or a paper shredder.

The average length of the fiber threads is not critical, but it is preferred that it be 0.1 mm or more and 7 mm or less, more preferably 0.1 mm or more and 5 mm or less, even more preferably 0.1 mm or more and 3 mm or less.

The average width (diameter) of the fiber threads is not critical, but it is preferred that it be 0.5 μm or more and 200 μm or less, more preferably 1.0 μm or more and 100 μm or less.

The average aspect ratio (proportion of the average length to the average width) of the fiber threads is not critical, but it is preferred that it be 10 or more and 1000 or less, more preferably 15 or more and 500 or less.

In such numerical ranges, the hold of the absorbent polymer 3 as well as the retention of ink Q and the delivery of the ink Q to the absorbent polymer 3 by the fiber are better, hence better ink absorption properties of the entire chip 1.

The absorbent polymer 3 only needs to be a polymer that has absorbency and can be of any kind, but examples include carboxymethyl cellulose, polyacrylic acid, polyacrylamide, starch-acrylic acid graft copolymers, hydrolysates of starch-acrylonitrile graft copolymers, vinyl acetate-acrylate copolymers, polymers like copolymers of isobutylene and maleic acid, hydrolysates of acrylonitrile copolymers or acrylamide copolymers, polyethylene oxide, polysulfonic-acid compounds, and polyglutamic acid and their salts (neutralized derivatives) and crosslinked forms. Here, absorbency refers to the ability to have hydrophilicity and retain water. Many of absorbent polymers 3 gel once they absorb water.

For the absorbent polymer 3, polymers having a pendant functional group are particularly preferred. Examples of functional groups include acid groups, the hydroxyl group, the epoxy group, and the amino group.

It is particularly preferred that the absorbent polymer 3 be a polymer having a pendant acid group, more preferably a polymer having a pendant carboxyl group.

Examples of carboxyl-containing units as a component of the absorbent polymer 3 include those derived from monomers such as acrylic acid, methacrylic acid, itaconic acid, maleic acid, crotonic acid, fumaric acid, sorbic acid, and cinnamic acid and their anhydrides and salts.

When an absorbent polymer 3 having a pendant acid group is contained, the percentage of acid groups in the absorbent polymer 3 neutralized to form a salt is preferably 30 mol % or more and 100 mol % or less, more preferably 50 mol % or more and 95 mol % or less, even more preferably 60 mol % or more and 90 mol % or less, the most preferably 70 mol % or more and 80 mol % or less. This leads to better ink Q absorbency of the absorbent polymer 3 (chip 1).

The salt of neutralization can be of any kind. Examples include alkali metal salts, such as the sodium salt, the potassium salt, and the lithium salt, and salts of nitrogen-containing basic compounds, such as ammonia, but the sodium salt is preferred. This leads to better ink Q absorbency of the absorbent polymer 3 (chip 1).

The preference for absorbent polymers 3 having a pendant acid group is because electrostatic repulsion between acid groups that occurs upon ink absorption accelerates the rate of absorption. The state in which acid groups have been neutralized, moreover, makes the ink Q easily absorbed into the absorbent polymer 3 by virtue of osmotic pressure.

The absorbent polymer 3 may have a constituent containing no acid group. Examples of such constituents include hydrophilic constituents, hydrophobic constituents, and constituents that serve as polymerizable crosslinkers.

Examples of hydrophilic constituents include constituents derived from nonionic compounds, such as acrylamide, methacrylamide, N-ethyl (meth)acrylamide, N-n-propyl (meth)acrylamide, N-isopropyl (meth)acrylamide, N,N-dimethyl (meth)acrylamide, 2-hydroxyethyl (meth)acrylate, 2-hydroxypropyl (meth)acrylate, methoxypolyethylene glycol (meth)acrylate, polyethylene glycol mono(meth)acrylate, N-vinylpyrrolidone, N-acryloylpiperidine, and N-acryloylpyrrolidine.

Examples of hydrophobic constituents include constituents derived from compounds such as (meth)acrylonitrile, styrene, vinyl chloride, butadiene, isobutene, ethylene, propylene, stearyl (meth)acrylate, and lauryl (meth)acrylate.

Examples of constituents that serve as polymerizable crosslinkers include diethylene glycol diacrylate, N,N′-methylenebisacrylamide, methylenebisacrylamide, polyethylene glycol diacrylate, polypropylene glycol diacrylate, trimethylolpropane diallyl ether, trimethylolpropane triacrylate, allyl glycidyl ether, pentaerythritol triallyl ether, pentaerythritol diacrylate monostearate, bisphenol diacrylate, isocyanuric acid diacrylate, tetraallyloxyethane, and diallyloxyacetates.

Preferably, the absorbent polymer 3 contains a polyacrylate copolymer or crosslinked polyacrylic-acid polymer. This brings advantages such as improved performance on absorbing ink Q and the possibility of reduced production cost.

A crosslinked polyacrylic-acid polymer is preferably one in which the percentage of constituents having a carboxyl group to all constituents forming the molecular chain is 50 mol % or more, more preferably 80 mol % or more, even more preferably 90 mol % or more.

Too low a percentage of carboxyl-containing constituents can make it difficult to achieve sufficiently good performance on absorbing ink Q.

Preferably, a subset of the carboxyl groups in the crosslinked polyacrylic-acid polymer have been neutralized (the polymer has been partially neutralized) to form a salt.

The percentage of neutralized carboxyl groups to all carboxyl groups in the crosslinked polyacrylic-acid polymer is preferably 30 mol % or more and 99 mol % or less, more preferably 50 mol % or more and 99 mol % or less, even more preferably 70 mol % or more and 99 mol % or less.

The absorbent polymer 3, moreover, may have a structure crosslinked with a crosslinker that is not a polymerizable crosslinker as mentioned above.

When the absorbent polymer 3 is a polymer having an acid group, compounds having multiple functional groups that react with acid groups, for example, are preferred for use as crosslinkers.

When the absorbent polymer 3 is a polymer having a functional group that reacts with acid groups, compounds having multiple functional groups that react with acid groups are suitable for use as crosslinkers.

Examples of compounds (crosslinkers) having multiple functional groups that react with acid groups include glycidyl ether compounds, such as ethylene glycol diglycidyl ether, trimethylolpropane triglycidyl ether, (poly)glycerol polyglycidyl ether, diglycerol polyglycidyl ether, and propylene glycol diglycidyl ether; polyhydric alcohols, such as (poly)glycerol, (poly)ethylene glycol, propylene glycol, 1,3-propanediol, polyoxyethylene glycol, triethylene glycol, tetraethylene glycol, diethanolamine, and triethanolamine; and polyamines, such as ethylenediamine, diethylenediamine, polyethyleneimine, and hexamethylenediamine. Substances like polyvalent ions, such as zinc, calcium, magnesium, and aluminum, are also suitable for use because they serve as crosslinkers by reacting with the acid group the absorbent polymer 3 has.

The absorbent polymer 3 may be in any shape, for example flake-shaped, needle-like, fibrous, or particulate, but preferably is particulate. A particulate absorbent polymer 3 helps ensure permeability to ink Q easily, and also provides a good hold of the absorbent polymer 3 on the fibrous support 2 (fiber). Preferably, the average diameter of the particles is 15 μm or more and 800 μm or less, more preferably 15 μm or more and 400 μm or less, even more preferably 15 μm or more and 50 μm or less.

The average diameter of the particles can be, for example, the mean volume diameter, or MVD, as measured using a laser-diffraction particle size distribution analyzer. A particle size distribution analyzer based on laser diffraction/scattering, or a laser-diffraction particle size distribution analyzer, provides volume-based measurement of particle size distribution.

Preferably, the absorbent polymer 3 relative to the fibrous support 2 is more than 5% by weight and 90% by weight or less, more preferably 20% by weight or more and 70% by weight or less, even more preferably 40% by weight or more and 55% by weight or less.

In addition, when the average diameter of the particles of the absorbent polymer 3 is D [μm], and the aforementioned average length of fiber threads is L [μm], it is preferred that 0.15≤L/D≤467. More preferably, 0.25≤L/D≤333. Even more preferably, 2≤L/D≤200.

The chip 1, furthermore, may contain ingredients other than those described above (extra ingredients). Examples of such ingredients include surfactants, lubricants, defoamers, fillers, anti-blocking agents, ultraviolet absorbers, coloring agents, such as pigments and dyes, flame retardants, and flow improvers.

The absorbent polymer 3 in the configuration illustrated in FIG. 3 is adhering to the front surface 21 and back surface 22 of the fibrous support 2, but this is not the only possible option. For example, the absorbent polymer 3 on one of the front surface 21 and the back surface 22 may be omitted.

The chip 1, furthermore, may be one that has an intermediate layer between the fibrous support 2 and the absorbent polymer 3. This intermediate layer can be of any kind. For example, it can be a layer that promotes bonding between the fibrous support 2 and the absorbent polymer 3.

Preferably, each chip 1 is elongated one (belt-shaped) as illustrated in FIGS. 1 and 2. This makes the chips 1 deform easily. When these chips 1 (chip aggregate 10) are packed into a container 9, the chips 1 deform whatever the internal shape of the container 9 is, or displays shape compliance, ensuring that the chip aggregate 10 is packed all together smoothly. The area of contact of the chip aggregate 10 as a whole with ink Q, moreover, is maximized, hence improved absorption performance (absorption properties) on absorbing ink Q. In addition, the smooth packing of the chips 1 (chip aggregate 10) prevents excessive deformation; as a result, the detachment of the absorbent polymer 3 from the fibrous support 2 is also prevented.

When the chips 1 are produced from waste paper, or paper that has been used, the waste paper is, for example, put into a paper shredder. The resulting shreds (cut pieces) can be used as fibrous supports 2 of the chips 1.

The total length (longitudinal length) L of the chip 1 is preferably 50 mm or more and 500 mm or less for example, more preferably 100 mm or more and 300 mm or less, although depending partly on the shape and size of the container 9 (see FIG. 2).

Likewise, the width (transverse length) W₁ of the chip 1 is preferably 50 mm or more and 500 mm or less for example, more preferably 100 mm or more and 300 mm or less, although depending partly on the shape and size of the container 9 (see FIG. 2).

The aspect ratio L₁/W₁ between the total length L₁ and the width W₁ is preferably 1.1 or more and 200 or less, more preferably 2 or more and 50 or less. The thickness t₁ of the chip 1, too, is preferably 50 μm or more and 2 mm or less for example, more preferably 0.1 mm or more and 1 mm or less (see FIG. 2).

The chip aggregate 10 may include chips 1 that are equal in at least one of total length L₁, width W₁, aspect ratio L₁/W, and thickness t₁, or may include chips 1 differing in all of these.

The shape of the chip 1 is elongated in this embodiment, but this is not the only possible option. For example, the shape of the chip 1 may be polygonal, such as square, triangle, or hexagonal, or a shape like a circle or oval, or even irregular like that of a hand-torn piece. It may even be that sets of chips 1 varying in shape and/or size intermingle.

As mentioned above, each chip 1 is elongated one (has a longitudinal dimension). Inside the container 9, the chips 1 are loaded in such a manner that each of them extends in different directions as illustrated in FIG. 1. That is, multiple chips 1 are present irregularly but as an aggregate in the container 9 so that the directions in which the chips 1 extend are not aligned (not parallel) but cross together. In other words, the chips 1 are packed randomly (with or without order; the same applies hereinafter) in two-dimensional directions (e.g., the direction along the bottom 91 (lower surface 82)) or three-dimensional directions (the three directions in the packing space 93) inside the container 9. In such a packing state, it is likely that gaps 20 are created between the chips 1. By virtue of this, ink Q can pass through the gaps 20 and, when the gaps 20 are microscopic, can spread by capillarity; that is, permeability to ink Q is guaranteed. This prevents the ink Q flowing downwards inside the container 9 from being interrupted, thereby allowing the ink Q to penetrate to the depths (bottom 91) of the container 9. This ensures equal absorption and long-term retention of the ink Q by the chips 1. The random packing of the chips 1 also increases the chance of contact of the chip aggregate 10 as a whole with ink Q; therefore, absorption performance on absorbing ink Q is improved. When the chip aggregate 10 is packed into a container 9, furthermore, the chips 1 can be put into the container 9 randomly; therefore, the packing work is easy and quick.

In addition, when the volume of the container 9 (packing space 93) is V1, and the total volume of the chip aggregate 10 that has yet to absorb ink Q (yet to absorb water) is V2, the ratio V2/V1 between V1 and V2 is preferably 0.1 or more and 0.7 or less, more preferably 0.2 or more and 0.7 or less (see FIG. 1). This creates a void 95 inside the container 9. The chips 1 expand (swell) after absorbing ink Q. The void 95 serves as a buffer when the chips 1 expand, thereby allowing the chips 1 to absorb sufficient ink Q.

### Embodiment 2

FIG. 4 is an exploded perspective diagram illustrating the relative positions of chip aggregates to be packed in an ink absorbing device according to the present invention.

The following describes an ink absorbing material, an ink absorbing device, and a droplet ejecting apparatus according to the present invention in Embodiment 2 with reference to this drawing. The following description, however, is centered on differences from the above embodiment, leaving out the description of similarities.

This embodiment is the same as Embodiment 1 above except that the chips are packed in the container in another way.

As illustrated in FIG. 4, each chip 1 is elongated one (one that has a longitudinal dimension). In the container 9, multiple chips 1 are present with all extending in the same horizontal direction (one particular direction) in FIG. 4. That is, the chips 1 are arranged regularly inside the container 9. Overlapping chips 1 are also included. Such a state of packing of chips 1 is an effective configuration, for example when ink Q flows down toward the bottom 91 inside the container 9 and the user wants to reduce its downflow speed (penetration speed).

It should be noted that the chip aggregate 10 includes multiple chips 1 that are regularly arranged, but besides these, it may include, for example, multiple chips 1 that are randomly arranged as described in Embodiment 1 above.

### Embodiment 3

FIG. 5 is an exploded perspective diagram illustrating the relative positions of chip aggregates to be packed in an ink absorbing device according to the present invention.

The following describes an ink absorbing material, an ink absorbing device, and a droplet ejecting apparatus according to the present invention in Embodiment 3 with reference to this drawing. The following description, however, is centered on differences from the above embodiments, leaving out the description of similarities.

This embodiment is the same as Embodiment 2 above except that the chips are packed in the container in another way.

As illustrated in FIG. 5, the chip aggregate 10 in the container 9 includes groups of chips 1 in which all chips 1 extend in the same horizontal direction in FIG. 5 (hereinafter referred to as “first chip groups 1A”) and those in which all chips 1 extend in the same, upper right-to-lower left direction in FIG. 5 (hereinafter referred to as “second chip groups 1B”). That is, the direction in which the chips 1 in the first chip groups 1A extend and that in which the chips 1 in the second chip groups 1B extend are at right angles. The first chip groups 1A and the second chip groups 1B, moreover, are alternated. Such a state of packing of chips 1 is an effective configuration, for example when the user wants to further reduce the downflow speed of the ink Q from that in Embodiment 2.

### Embodiment 4

FIG. 6 is a plan view of a chip aggregate to be packed in an ink absorbing device according to the present invention. FIG. 7 is a plan diagram illustrating the chip aggregate of FIG. 6 in a container. FIG. 8 is a cross-sectional view along line B-B in FIG. 7. FIG. 9 is a cross-sectional view along line C-C in FIG. 7. FIG. 10 is a vertical cross-sectional diagram illustrating a variation of chip aggregates packed in an ink absorbing device according to the present invention.

The following describes an ink absorbing material, an ink absorbing device, and a droplet ejecting apparatus according to the present invention in Embodiment 4 with reference to these drawings. The following description, however, is centered on differences from the above embodiments, leaving out the description of similarities.

This embodiment is the same as Embodiment 1 above except that it has a different configuration of chip aggregates.

As illustrated in FIG. 6, a chip aggregate 10 in this embodiment has a connector 4 that connects multiple chips 1 (in particular, their ends) together. This ensures that when the chip aggregate 10 is packed into a container 9, multiple chips 1 can be put into the container 9 by holding the connector 4 and casting it together with the connected chips 1. As a result, the packing of the chip aggregate 10 into the container 9 is easy and quick.

Preferably, the connector 4 also has a fiber-containing fibrous support 2 and an absorbent polymer 3 held on the fibrous support 2 like the chip 1. That is, the connector 4 can be made by preparing a piece of paper material (sheet), making multiple parallel slits (cuts) from a first end toward a second end, and stopping cutting partway (before the cuts reach the second end). The multiple chips 1 therefore form a chip aggregate 10 as a result of serial connection of their second ends along the transverse dimension of the chips. Alternatively, the connector 4 may be a separate component, such as a piece of paper tape, a stapler, or any other binding tool.

The number of chips 1 connected by the connector 4 is eight in this embodiment, but does not need to be this as long as it is two or more.

The connector 4, moreover, does not need to be one that connects the second ends of chips 1 together. For example, the connector 4 may be one that connects somewhere along the longitudinal dimension of the chips 1 (part of each chip 1) together. In this case, too, the packing of the chip aggregate 10 into the container 9 is easy and quick.

In the container 9, one sheet connected by the connector 4 (chip aggregate 10) may be packed, or a stack of more than one of such sheets may be packed.

In the container 9, furthermore, multiple chips 1 may be packed separately from (independently of) each other. In this case, the container 9 may contain multiple chips 1 that are arranged as described in Embodiment 1 above, or may contain multiple chips 1 that are regularly arranged as described in Embodiment 2 above.

As illustrated in FIG. 7, the container 9 in this embodiment has a protrusion 921 sticking (projecting) toward the inside on one side wall 92 of the four side walls 92. The opposite of this protrusion 921 is recessed to provide, for example, an escape space that prevents the ink absorbing device 100 from interfering with surrounding components when installed in a printing apparatus 200.

The container 9 in this embodiment has a protrusion 921 on one side wall 92 of the four side walls 92, but this is not the only possible option. For example, there may be a protrusion 921 on two, three, or four (all) side walls 92.

As mentioned above, each chip 1 is elongated one. In the container 9, moreover, these chips 1 include folded ones. That is, the multiple chips 1 include ones that have a folded portion 12 created by folding the end opposite the connector 4 (see FIGS. 7 and 9). This folded portion 12 adjusts the length of the chips 1 inside the container 9, preventing the chips 1 from interfering with the protrusion 921. By virtue of this, it is easy to pack the chip aggregate 10 into the container 9. The packed chip aggregate 10 is also stable. Those chips 1 that have a folded portion 12, furthermore, have an increased (adjusted) thickness inside the container 9 proportionally to the folding.

The chips 1 other than those chips 1 that have a folded portion 12 are straight at the end opposite the connector 4 (see FIG. 8).

Meanwhile, inside the variation container 9 illustrated in FIG. 10, multiple chip aggregates 10 are packed each having a connector 4 that connects multiple chips 1 together, and they are packed randomly in two-dimensional directions or three-dimensional directions. In each chip aggregate 10, the chips 1 may be folded or twisted; that is, they may have been deformed to the desired shape. Such a packing state also provides quick absorption of ink Q.

### Embodiment 5

FIG. 11 is a perspective view of a chip as a member of a chip aggregate included in an ink absorbing device according to the present invention.

The following describes an ink absorbing material, an ink absorbing device, and a droplet ejecting apparatus according to the present invention in Embodiment 5 with reference to this drawing. The following description, however, is centered on differences from the above embodiments, leaving out the description of similarities.

This embodiment is the same as Embodiment 1 above except that the shape of the chips is different.

As illustrated in FIG. 11, the chips 1 in this embodiment have bends (folds) 11 that bend (or curve) the longitudinal dimension of the chips 1 back and forth multiple times, in the opposite direction from time to time. That is, the chips 1 are corrugated. Such deformed chips 1 are obtained by, for example, bulking. This makes the chips 1 bulky ones, thereby increasing the chance of contact with ink Q per chip 1. As a result, the amount of ink Q absorbed is maximized.

The bends 11 may be portions made by bending the width dimension of the chips 1 back and forth, in the opposite direction from time to time.

Making multiple bends 11 is not the only possible option; the number of bends 11 may be one.

### Embodiment 6

FIG. 12 is a perspective view of a chip as a member of a chip aggregate included in an ink absorbing device according to the present invention.

The following describes an ink absorbing material, an ink absorbing device, and a droplet ejecting apparatus according to the present invention in Embodiment 6 with reference to this drawing. The following description, however, is centered on differences from the above embodiments, leaving out the description of similarities.

This embodiment is the same as Embodiment 5 above except that the shape of the chips is different.

As illustrated in FIG. 12, the chips 1 in this embodiment are ones that have at least one twist somewhere along their longitudinal dimension. This makes the chips 1 bulky ones, thereby increasing the chance of contact with ink Q per chip 1. As a result, the amount of ink Q absorbed is maximized.

Twist(s) and the aforementioned bend(s) 11 may intermingle in one single chip 1. Alternatively, the chip aggregate 10 may be one that includes at least two types of chips 1 having the shape in FIG. 2, those having the shape in FIG. 11, and those having the shape in FIG. 12 as needed.

### Embodiment 7

FIG. 13 is a vertical cross-sectional view of a chip as a member of a chip aggregate included in an ink absorbing device according to the present invention.

The following describes an ink absorbing device according to the present invention with reference to these drawings. The following description, however, is centered on differences from the above embodiments, leaving out the description of similarities.

This embodiment is the same as Embodiment 1 above except that the relative positions of the fibrous support and the absorbent polymer are different.

As illustrated in FIG. 13, the absorbent polymer 3 with the fibrous support 2 in this embodiment is somewhere in the thickness dimension of the fibrous support 2. That is, the absorbent polymer is spread inside the fibrous support 2 in the direction of thickness. This ensures that ink Q is retained (absorbed) as close to the middle of the sheets 1 in the direction of their thickness as it can be, hence extended retention of the ink Q. The detachment of the absorbent polymer 3 from the fibrous support 2 is also prevented.

The absorbent polymer 3 may be dispersed evenly in the direction of thickness or may be localized at the front surface 21 or back surface 22 of the fibrous support 2.

In addition, the combination with the configuration illustrated in FIG. 3 is permitted; that is, the absorbent polymer 3 may be present on (adhering to) at least one side of the fibrous support 2 (front surface 21 and/or back surface 22), too.

### Embodiment 8

FIG. 14 is a perspective diagram illustrating an ink absorbing device according to the present invention.

The following describes an ink absorbing material, an ink absorbing device, and a droplet ejecting apparatus according to the present invention with reference to this drawing. The following description, however, is centered on differences from the above embodiments, leaving out the description of similarities.

This embodiment is the same as Embodiment 1 above except that the structure of the container is different.

As illustrated in FIG. 14, the container 9 in this embodiment is a flexible one, i.e., a soft and bag-shaped one. In other words, the container 9 is one that has shape retainability low enough that it changes its volume V1 by 10% or more when internal pressure or an external force acts thereon. In FIG. 14, the ink absorbing device 100 is a “pillow-packed” one. Such a container 9 can be deformed as needed in the place where the ink absorbing device 100 is installed. By virtue of this, the ink absorbing device 100 stays in a stable position, allowing the chips 1 (chip aggregate 10) to absorb ink Q consistently. Even when the chips 1 expand by absorbing ink Q, furthermore, the container 9 deforms to follow the expansion. This embodiment also contributes to reducing the weight of the ink absorbing device 100 (container 9).

In the middle of the top surface 96 of the container 9 is a connection port 97 to which the tube 203 is connected. This connection port 97 is tube-shaped and has been formed to stick upwards.

The material for the container 9 is not critical. Examples include polyolefins, such as polyethylene and ethylene-vinyl acetate (EVA) copolymers, polyesters, such as polyethylene terephthalate (PET) and polybutylene terephthalate (PBT), and thermoplastic elastomers, such as polyurethane.

The foregoing description of ink absorbing materials, ink absorbing devices, and droplet ejecting apparatuses according to the present invention in illustrated embodiments does not mean the present invention is limited to them. Each structural element of the ink absorbing materials, ink absorbing devices, and droplet ejecting apparatuses can be replaced with one having any other configuration that provides the same function. There may be any component added to it.

An ink absorbing material, an ink absorbing device, and a droplet ejecting apparatus according to the present invention, furthermore, may be combinations of any two or more configurations (features) in the above embodiments.

In addition, the use of the ink absorbing devices according to the present invention in the above embodiments is a “waste liquid tank (waste ink tank),” but this is not the only possible option. For example, it may be a “receiver for ink leakages” that absorbs ink that has accidentally leaked out of an ink channel of a printing apparatus.

### Embodiment 9

FIG. 15 is a perspective diagram illustrating an exemplary form of an ink absorbing material according to the present invention. FIG. 16 is a perspective view of the ink absorbing material illustrated in FIG. 15. FIG. 17 is a cross-sectional view of the ink absorbing material illustrated in FIG. 15. FIG. 18 is a diagram illustrating a production process for the production of the ink absorbing material illustrated in FIG. 15, illustrating the application of an adhesive agent. FIG. 19 is a diagram illustrating a production process for the production of the ink absorbing material illustrated in FIG. 15, illustrating the supply of an absorbent polymer. FIG. 20 is a diagram illustrating a production process for the production of the ink absorbing material illustrated in FIG. 15, illustrating the heating and compression of a sheet-shaped fibrous support. An ink absorbing device that includes the chips (ink absorbing material) of the ink absorbing device illustrated in FIG. 15 has the same cross-sectional view as FIG. 1 for Embodiment 1.

As illustrated in FIGS. 15 to 17, the ink absorbing material 10 is a chip aggregate 10 that includes multiple chips 1 each having a fiber-containing fibrous support 2 and an absorbent polymer 3 at least part of which is spread inside the fibrous support 2.

This ensures that when ink Q is supplied to the chip aggregate 10, the chance of contact between the chips 1 and the ink Q and the area of contact between the ink Q and the chips 1 are greater than when the ink absorbing material is made with a fibrous support formed as plate-shaped (sheet-shaped) blocks. In this state, the fiber (fibrous support 2) retains the ink Q temporarily. The ink Q can then be sent from the fiber to the absorbent polymer 3 more efficiently, hence improved ink Q absorption properties of the chip aggregate 10 as a whole.

Being a chip aggregate 10 including multiple chips 1, furthermore, the ink absorbing material 10 can change its shape freely. This means the desired amount (appropriate amount) of it can be packed into the container 9 (see FIG. 1), and, for example, its bulk density is easily adjustable. As a result, unevenness in ink Q absorption properties is prevented.

Since the absorbent polymer 3 has at least in part spread inside the fibrous support 2, furthermore, the absorbent polymer 3 does not easily separate from the fibrous support 2. This allows the ink absorbing material 10 to exhibit high ink Q absorption properties as mentioned above for a long period of time and helps prevent the detachment of the absorbent polymer 3 inside the container 9. Uneven distribution of the absorbent polymer 3 inside the container 9 is therefore prevented. As a result, unevenness in ink Q absorption properties is prevented.

It should be noted that “absorbent” as mentioned herein naturally means that the polymer absorbs water-based inks, which are solutions of colorant(s) in an aqueous medium or media, but also embraces the ability of the polymer to absorb inks in general, including solvent-based inks, which are solutions of binder(s) in solvent(s), UV-curable inks, which are solutions of binder(s) in liquid monomer(s) that cures in response to UV irradiation, and latex inks, which are dispersions of binder(s) in a dispersion medium or media.

In the chip aggregate 10, each chip 1 has substantially the same structure. In the following, therefore, one chip 1 is described as a representative example.

A chip 1 has a fiber-containing fibrous support 2 and an absorbent polymer 3 held on the fibrous support 2 as mentioned above, and also has an adhesive agent 5. In this embodiment, most of the pieces of the fibrous support 2 are strip-shaped, i.e., rectangular in plan view.

The absorbent polymer 3 is held on one side of the fibrous support 2 (in the structure illustrated in FIG. 17, the front surface 21). By virtue of this, the ink Q that reaches the front surface 21 is absorbed, and the ink Q that reaches the back surface 22 is spread (allowed to permeate) quickly.

The fibrous support 2 may hold the absorbent polymer 3 on its back surface 22, too. In that case, it is preferred that the amount of adhering absorbent polymer 3 differ between the front surface 21 and the back surface 22. This ensures good absorption and spread of ink Q.

By virtue of the fibrous support 2, the absorbent polymer 3 is held well, and the detachment of the absorbent polymer 3 from the fibrous support 2 is prevented better. When ink Q is supplied to the chip 1, moreover, the fiber (fibrous support 2) retains the ink Q temporarily. The ink Q is then sent to the absorbent polymer 3 more efficiently, hence improved ink Q absorption properties of the entire chip 1. In general, furthermore, fibers such as cellulose fiber (in particular, fiber recycled from waste paper) are low-priced compared with absorbent polymers 3, which makes fibers also advantageous in terms of reducing the cost of producing the chips 1. The use of fiber is also advantageous in terms of waste minimization, effective use of resources, etc.

The fiber can be selected from the same types of fibers as described in Embodiment 1. Cellulose is a material of good hydrophilicity, and, when ink Q is supplied to the chip 1, it allows the chip 1 to trap the ink Q well. The ink Q therefore quickly escapes a state of being extremely fluidic (e.g., a state in which its viscosity is 10 mPa·s or less), and the chip 1 sends the temporarily trapped ink Q to the absorbent polymer 3 well. As a result, the ink Q absorption properties of the entire chip 1 are superb. By virtue of the high compatibility of cellulose with absorbent polymers 3 in general, moreover, the absorbent polymer 3 is held on the surface of the fiber better. In addition, being a renewable natural material and low-priced and readily available even when compared with other fibers, cellulose fiber is also advantageous in terms of reducing the cost of producing the chips 1, stable production of the chips 1, reducing environmental burdens, etc.

For the average length of the fiber threads, the average width (diameter) of the fiber threads, and the average aspect ratio (proportion of the average length to the average width) of the fiber threads, what is described in Embodiment 1 applies the same way.

In such numerical ranges, the hold of the absorbent polymer 3 as well as the retention of ink Q and the delivery of the ink Q to the absorbent polymer 3 by the fiber are better, hence better ink absorption properties of the entire chip 1. For the absorbent polymer 3, those that are described in Embodiment 1 can be used in the same way; therefore, its details are left out in the following description.

Preferably, the absorbent polymer 3 is particulate. A granular polymer refers to one whose aspect ratio (ratio between the largest length and the least length) is 0.3 or more and 1.0 or less. The average diameter of the chips is preferably 50 μm or more and 800 μm or less, more preferably 100 μm or more and 600 μm or less, even more preferably 200 μm or more and 500 μm or less.

The chip 1, like that described in Embodiment 1, may contain ingredients other than those described above (extra ingredients).

As illustrated in FIG. 17, furthermore, the absorbent polymer 3 is held on (bound to) one side of the fibrous support 2. The absorbent polymer 3, moreover, has partly penetrated into the fibrous support 2 from this side. That is, part of the absorbent polymer 3 is spread inside the fibrous support 2. This strengthens the hold of the absorbent polymer 3 on the fibrous support 2. The detachment of the absorbent polymer 3 inside the container 9 is therefore prevented. As a result, the ink absorbing material 10 exhibits its high ink absorption properties for a long period of time, and helps prevent the absorbent polymer 3 from detaching inside the container 9, and uneven distribution of the absorbent polymer 3 inside the container 9 is therefore prevented, unevenness in ink Q absorption properties is prevented.

“Having spread inside” as mentioned herein refers to an embedded (buried) state in which at least part of the particles of the absorbent polymer 3 has penetrated into the fibrous support 2 from its surface. Not all particles need to have spread. “Having spread inside” also includes the state in which particles of the absorbent polymer 3 have been softened to penetrate completely through the fibrous support 2, sticking out on the back surface of the fibrous support 2.

Preferably, the absorbent polymer 3 content of the chip 1 is 25% by weight or more and 300% by weight of less, more preferably 50% by weight or more and 150% by weight or less, of the fiber. This helps ensure sufficient water absorption and permeability.

When the absorbent polymer 3 content of the chip 1 is too small, water absorption can be insufficient. When the absorbent polymer 3 content of the chip 1 is too large, the coefficient of expansion of the chip 1 tends to be so high that permeability may be low.

The ink absorbing material 10, furthermore, includes an adhesive agent 5. The adhesive agent 5 is a component that sticks the fibrous support 2 and the absorbent polymer 3 together and also sticks pieces of the absorbent polymer 3 and fiber threads together. This strengthens the hold of the absorbent polymer 3 on the fibrous support 2, ensuring that the absorbent polymer 3 does not easily detach from the fiber. It is therefore more certain that the aforementioned effects are produced.

The adhesive agent 5 can be water, a water-soluble adhesive agent, an organic adhesive agent, etc. When the adhesive agent 5 is a water-soluble adhesive agent, the absorption of ink Q by the absorbent polymer 3 is not inhibited by the water-soluble adhesive agent. Even when the ink Q is water-based and the water-soluble adhesive agent is on the surface of the absorbent polymer 3, the water-soluble adhesive agent dissolves upon contact of the ink Q with the adhesive agent 5.

Examples of water-soluble adhesive agents include proteins, such as casein, soy protein, and synthetic proteins, starches, such as starch and oxidized starch, polyvinyl alcohols including modified polyvinyl alcohols, such as polyvinyl alcohol, cationic polyvinyl alcohols, and silyl-modified polyvinyl alcohols, cellulose derivatives, such as carboxymethyl cellulose and methyl cellulose, water-based polyurethane resins, and water-based polyester resins.

Of such adhesive agents, the use of polyvinyl alcohol is particularly preferred in terms of surface strength. This ensures the strength of the bonding between the fibrous support 2 and the absorbent polymer 3 is sufficiently high.

In addition, selecting the type of adhesive agent according to the ink Q to be absorbed ensures that the above effects are produced regardless of the type of ink Q.

Preferably, the adhesive agent 5 content of the chip 1 is 1.0% by weight or more and 70% by weight or less, more preferably 2.5% by weight or more and 50% by weight or less, of the fiber. This makes the advantages of the presence of the adhesive agent 5 more significant. When the adhesive agent 5 content is too small, the advantages of the presence of the adhesive agent 5 are not sufficient. When the adhesive agent 5 content is too large, likewise, there cannot be a more significant improvement in the hold of the absorbent polymer 3.

Preferably, each chip 1 is one that is flexible and elongated (belt-shaped) as illustrated in FIG. 16. This makes the chips 1 deform easily. When these chips 1 (chip aggregate 10) are packed into the container 9, the chips 1 deform whatever the internal shape of the container 9 is, or displays compliance with the container shape, ensuring that the chip aggregate 10 is packed all together smoothly. The area of contact of the chip aggregate 10 as a whole with ink Q, moreover, is maximized, hence improved absorption performance (absorption properties) on absorbing ink Q.

The total length (longitudinal length) of the chip 1 is preferably 0.5 mm or more and 200 mm or less for example, more preferably 1 mm or more and 100 mm or less, even more preferably 2 mm or more and 30 mm or less, although depending partly on the shape and size of the container 9 (see FIG. 16).

Likewise, the width (transverse length) of the chip 1 is preferably 0.1 mm or more and 100 mm or less for example, more preferably 0.3 mm or more and 50 mm or less, even more preferably 1 mm or more and 20 mm or less, although depending partly on the shape and size of the container 9.

The aspect ratio, between the total length and the width, is preferably 1 or more and 200 or less, more preferably 1 or more and 30 or less. The thickness of the chip 1, too, is 0.05 m or more and 2 mm or less, more preferably 0.1 mm or more and 1 mm or less (see FIG. 16).

In such numerical ranges, the hold of the absorbent polymer 3 as well as the retention of ink Q and the delivery of the ink Q to the absorbent polymer 3 by the fiber are better, hence better ink Q absorption properties of the entire chip 1. The chip aggregate 10 as a whole, moreover, is easily deformable and therefore is superior in compliance with the shape of containers 9.

In addition, the chip aggregate 10 may include chips 1 differing in size and/or shape.

The chip aggregate 10, moreover, may include chips 1 that are equal in at least one of total length, width, aspect ratio, and thickness, or may include chips 1 differing in all of these.

Preferably, the amount of chips 1 whose maximum width is 3 mm or less in the chip aggregate 10 is 30% by weight or more and 90% by weight or less, more preferably 40% by weight or more and 80% by weight or less. This leads to more effective prevention of unevenness in ink absorption properties.

When the amount of chips 1 whose maximum width is 2 mm or less is too small, it is likely that gaps are created between the chips 1 when the chip aggregate 10 is packed into the container 9. Inside the container 9, therefore, the ink Q absorption properties may be uneven. When the amount of chips 1 whose maximum width is 2 mm or less is too large, it tends to be so difficult to create gaps between the chips 1 that the bulk density of the chip aggregate 10 is not easily adjustable.

Preferably, the chips 1 are in a regular shape. That is, the chips 1 are preferably ones cut into a regular shape, for example using a paper shredder. This makes it unlikely that the bulk density of the chip aggregate 10 is uneven, thereby helping prevent unevenness in ink Q absorption properties inside the container 9. Chips 1 cut into a regular shape help minimize the area of cross-sections. The use of such chips 1 therefore helps control the production of dust (scattering of the fiber and/or absorbent polymer) while ensuring adequate ink absorption properties.

A “regular shape” refers to, for example, a polygonal shape, such as rectangular, square, triangle, or pentagonal, or a shape like a circle or an oval. The chips 1 may have the same dimensions and may be in similar shapes. For example, rectangular chips 1 are deemed to have a regular shape even when they vary in the length of the sides, as long as they fit the definition of a rectangle (the same applies to the other shapes, too).

Preferably, the amount of such chips 1 having a regular shape is 30% by weight or more, more preferably 50% by weight or more, even more preferably 70% by weight or more of the chip aggregate 10 as a whole.

For the chips 1, furthermore, it may be that the chips 1 are in irregular shapes. This ensures that the chips 1 easily become entangled, thereby helping prevent the division or localization of the chip aggregate 10, it becomes easier to maintain the shape of the chip aggregate 10 as a whole. Chips 1 having irregular shapes, moreover, helps maximize the area of cross-sections (surfaces created by tearing), thereby helping further increase the area of contact with ink Q. The use of such chips 1 therefore contributes to quick absorption of ink Q.

An “irregular shape” refers to one that is not a “regular shape” as described above, such as the shape of roughly cut or hand-torn pieces (see FIG. 15).

The chip aggregate 10, furthermore, may be one in which such chips 1 having a regular shape and chips 1 having irregular shapes intermingle. This allows the chip aggregate 10 to share both of the advantages described above.

As mentioned above, each chip 1 is elongated one (has a longitudinal dimension). Inside the container 9, the chips 1 are loaded in such a manner that each of them extends in different directions. That is, multiple chips 1 are present irregularly but as an aggregate in the container 9 so that the directions in which the chips 1 extend are not aligned (not parallel) but cross together. In other words, the chips 1 are packed randomly (with or without order) in two-dimensional directions (e.g., the direction along the bottom 91) or three-dimensional directions (the three directions in the packing space 93) inside the container 9.

In such a packing state, it is likely that gaps are created between the chips 1. By virtue of this, ink Q can pass through the gaps and, when the gaps are microscopic, can spread by capillarity; that is, permeability to ink Q is guaranteed. This prevents the ink Q flowing downwards inside the container 9 from being interrupted, thereby allowing the ink Q to penetrate to the depths (bottom 91) of the container 9. This ensures equal absorption and long-term retention of the ink Q by the chips 1.

In addition, the chip aggregate 10 can change its shape freely. This means the desired amount (appropriate amount) of it can be packed into the container 9, and, for example, its bulk density is easily adjustable. As a result, unevenness in ink Q absorption properties is prevented.

The random packing of the chips 1 also increases the chance of contact of the chip aggregate 10 as a whole with ink Q; therefore, absorption performance on absorbing ink Q is improved. When the chip aggregate 10 is packed into a container 9, furthermore, the chips 1 can be put into the container 9 randomly; therefore, the packing work is easy and quick.

In addition, when the volume of the container 9 (packing space 93) is V1, and the total volume of the chip aggregate 10 that has yet to absorb ink Q (yet to absorb water) is V2, the ratio between V1 and V2, V2/V1, is preferably 0.1 or more and 0.7 or less, more preferably 0.2 or more and 0.7 or less (see FIG. 1). This creates a void 95 inside the container 9. The chips 1 expand (swell) after absorbing ink Q. The void 95 serves as a buffer when the chips 1 expand, thereby allowing the chips 1 to absorb sufficient ink Q.

Preferably, the bulk density of the chip aggregate 10 is 0.01 g/cm³ or more and 0.5 g/cm³ or less, more preferably 0.03 g/cm³ or more and 0.3 g/cm³ or less. Within these, it is particularly preferred that the bulk density of the chip aggregate 10 be 0.05 g/cm³ or more and 0.2 g/cm³ or less. This ensures good retention and permeation of ink Q.

When the bulk density of the chip aggregate 10 is too small, the absorbent polymer 3 content tends to be so low that the retention of ink Q can be insufficient. When the bulk density of the chip aggregate 10 is too large, the permeation of ink Q can be insufficient because the gaps between the chips 1 are not sufficient in such a case.

Being flexible and therefore deformable, furthermore, the chips 1 allow the manufacturer to adjust the bulk density of the chip aggregate 10 easily and properly, helping achieve such a bulk density as specified above.

Next, a method for producing the ink absorbing material 10 is described.

This production method has a placement step, a water supply step (adhesive agent supply step), and a heating and compression step.

First, as illustrated in FIG. 18, a sheet-shaped fibrous support 2, which has yet to be cut into chips 1, is mounted on a stage 300 (placement step).

Then a liquid adhesive agent 5 (e.g., water or a water-soluble adhesive agent) is supplied to one side of the sheet-shaped fibrous support 2 (water supply step or adhesive agent supply step). Examples of methods for this supplying task include spray coating as well as soaking a sponge roller in water, a water-soluble adhesive agent, etc., and then rolling the sponge roller on one side of the sheet-shaped fibrous support 2.

Then, as illustrated in FIG. 19, an absorbent polymer 3 is supplied to one side of the sheet-shaped fibrous support 2, with a mesh element 400 therebetween. The mesh element 400 has mesh openings 401; particles of the absorbent polymer 3 larger than the mesh openings 401 are trapped on the mesh element 400, and chips smaller than the mesh openings 401 pass through the mesh openings 401 and are supplied to one side of the sheet-shaped fibrous support 2.

In this way, the use of a mesh element 400 helps make the diameter of the particles of the absorbent polymer 3 as uniform as it can be. It therefore helps prevent absorbency from varying from point to point of the fibrous support 2.

Preferably, the maximum width of the mesh openings 401 is 0.06 mm or more and 0.15 mm or less, more preferably 0.08 mm or more and 0.12 mm or less. This ensures that the diameter of the particles of the absorbent polymer 3 supplied to the fibrous support 2 is in any of the numerical ranges specified above.

The shape of the mesh openings 401 is not critical; they can be in any shape, such as a triangle, a quadrangle, a polygon with five or more sides, a circle, or an oval.

Then, as illustrated in FIG. 20, the sheet-shaped fibrous support 2 with an attached absorbent polymer 3 is placed between a pair of heating blocks 500. Then the pair of heating blocks 500 are heated, and the fibrous support 2 is compressed in the direction of thickness by pressing the heating blocks 500 to bring them closer to each other (heating and compression step). This causes the absorbent polymer 3 containing water or (a water-soluble adhesive agent) to soften as a result of heating, and also to enter the inside of the fibrous support 2 as a result of compression. Stopping heating and compression makes the water (or water-soluble adhesive agent) dry and the absorbent polymer 3 become bonded to the fibrous support 2 while present inside the fibrous support 2, completing a state in which the absorbent polymer 3 is spread inside the fibrous support 2 (see FIG. 17).

Preferably, the compression force in this step is 0.1 kg/cm² or more and 1.0 kg/cm² or less, more preferably 0.2 kg/cm² or more and 0.8 kg/cm² or less. The heating temperature in this step is preferably 80° C. or more and 160° C. or less, more preferably 100° C. or more and 120° C. or less.

Then the sheet-shaped fibrous support 2 is finely shredded, coarsely milled, or pulverized, for example using scissors, a utility knife, a mill, or a paper shredder, or manually torn into small pieces, giving a chip aggregate 10 formed by chips 1.

Then the desired amount is weighed out of this chip aggregate 10 and packed into a container 9 after bulk density adjustment, for example by manual disentangling, to give an ink absorbing device 100.

An ink absorbing material 10 has been described up to this point. The ink absorbing device 100 and the printing apparatus 200 that include the ink absorbing material 10 are not described; they are the same as described in Embodiment 1 with reference to FIG. 1.

The ink absorbing material 10 is made with a chip aggregate 10. The chip aggregate 10 includes multiple chips 1 that are flexible, and, in this embodiment, is used with these chips 1 packed all together in a container 9. This makes the chip aggregate 10 an ink absorbing device 100. As mentioned above, the ink absorbing device 100 is attached to a printing apparatus 200 and in that state is capable of absorption of waste ink Q.

The number of chips 1 packed into the container 9 is not critical. For example, as many chips 1 as needed are selected according to the relevant conditions, such as the purpose of use of the ink absorbing device 100. The ink absorbing device 100 is therefore one that is simple in structure, as many chips 1 as needed packed in a container 9. The quantity of packed chips 1 determines the maximum amount of ink Q absorbed at the chip aggregate 10 (ink absorbing device 100).

### Embodiment 10

FIG. 21 is a cross-sectional view of a chip included in the ink absorbing device illustrated in FIG. 1. FIG. 22 is a diagram illustrating a production process for the production of the ink absorbing material illustrated in FIG. 21, illustrating a sheet-shaped fibrous support folded with water (or a water-soluble adhesive agent) and an absorbent polymer supplied thereto. FIG. 23 is a diagram illustrating a production process for the production of the ink absorbing material illustrated in FIG. 21, illustrating the heating and compression of a sheet-shaped fibrous support.

The following describes a chip aggregate and an ink absorbing device according to the present invention in Embodiment 10 with reference to these drawings. The following description, however, is centered on differences from the above embodiments, leaving out the description of similarities.

This embodiment is the same as Embodiment 9 above except that the structure of the chips inside the container is different.

As illustrated in FIG. 21, the chips 1 in this embodiment has a stack of multiple (in the illustrated structure, two) fibrous supports 2. The absorbent polymer 3 is between the fibrous supports 2. This is therefore a structure in which the absorbent polymer 3 is sandwiched between and covered with the fibrous supports 2. By virtue of this, it is even more unlikely that the absorbent polymer 3 detaches from the fibrous supports 2. As well as the ink absorbing material exhibits high ink absorption properties for a longer period of time, uneven distribution of the absorbent polymer 3 inside the container 9 is prevented more effectively; as a result, unevenness in ink Q absorption properties is prevented.

It should be noted that this embodiment is not limited to the illustrated structure. The chips 1 may have a structure in which three or more fibrous supports 2 are stacked.

Next, a method for producing the ink absorbing material 10 is described.

This production method has a placement step, a water supply step (adhesive agent supply step), a folding step, and a heating and compression step. The placement step and the water supply step (adhesive agent supply step) are not described; they are the same as in Embodiment 9 above.

As illustrated in FIG. 22, a sheet-shaped fibrous support 2 that has completed the placement step and the water supply step (adhesive agent supply step) is folded in half (folding step). The fibrous support 2 is folded in two in such a manner that the surface coated with the absorbent polymer 3 in a first half will come into contact with that in the second.

Then, as illustrated in FIG. 23, the folded sheet-shaped fibrous support 2 is placed between a pair of heating blocks 500. Then the pair of heating blocks 500 are heated, and the fibrous support 2 is compressed in the direction of thickness by pressing the heating blocks 500 to bring them closer to each other (heating and compression step). This causes the absorbent polymer 3 containing water or (a water-soluble adhesive agent) to soften as a result of heating, and also to enter the inside of the fibrous support 2 as a result of compression. The particles of the absorbent polymer 3 laid on one another as a result of folding also soften and become bonded together.

Stopping heating and compression makes the water (or water-soluble adhesive agent) dry and the absorbent polymer 3 become bonded to the fibrous support 2 while present inside the fibrous support 2, completing a state in which the absorbent polymer 3 is spread inside the fibrous support 2. The portions of the fibrous support 2 stacked as a result of folding are also bonded together by the absorbent polymer 3 and water (or water-soluble adhesive agent).

Then the sheet-shaped fibrous support 2 is finely shredded, coarsely milled, or pulverized, for example using scissors, a utility knife, a mill, or a paper shredder, or manually torn into small pieces, giving a chip aggregate 10 formed by chips 1.

Then the desired amount is weighed out of this chip aggregate 10 and packed into a container 9 after bulk density adjustment, for example by manual disentangling, to give an ink absorbing device 100.

In such a production method, the structure of stacked fibrous supports 2 can be produced easily by folding one fibrous support 2 coated with an absorbent polymer 3 and an adhesive agent 5 (water or a water-soluble adhesive agent), or without the work of coating each of two fibrous supports 2 with an absorbent polymer 3 and an adhesive agent 5 (water or a water-soluble adhesive agent). The production process is therefore simple.

In the heating and compression step, furthermore, the heating blocks 500 come into contact with the surface of the fibrous support 2 with no adhering absorbent polymer 3; therefore, the adhesion of the absorbent polymer 3 to the heating blocks 500 is prevented. Requiring no step of washing the heating blocks 500, this production method is superior in productivity.

The foregoing description of ink absorbing materials, ink absorbing devices, and droplet ejecting apparatuses according to the present invention in illustrated embodiments does not mean the present invention is limited to it. Each structural element of the chip aggregates and the ink absorbing devices can be replaced with one having any other configuration that provides the same function. There may be any component added to it.

An ink absorbing material, an ink absorbing device, and a droplet ejecting apparatus according to the present invention, furthermore, may be combinations of any two or more configurations (features) in the above embodiments.

In addition, the use of the ink absorbing devices according to the present invention in the above embodiments is a “waste liquid tank (waste ink tank), but this is not the only possible option. For example, it may be a “receiver for ink leakages” that absorbs ink that has accidentally leaked out of an ink channel of a printing apparatus.

### EXAMPLES

Next, specific examples of the present invention are described.

### Example 1

### [1] Production of an Ink Absorbing Material

First, a sheet of waste paper measuring 30 cm long, 22 cm wide, and 0.5 mm thick (A4 sheet-shaped fibrous support) was prepared. The average length, average width, and aspect ratio (average length/average width) of the fiber threads contained in this sheet of waste paper were 0.71 mm, 0.2 mm, and 3.56, respectively. The weight of the waste paper was 4 g/sheet.

Then one side of this sheet of waste paper was sprayed with a small amount of water using a spray bottle.

Then SANFRESH 500MPSA (Sanyo Chemical Industries) as a crosslinked polyacrylic-acid polymer (partially sodium polyacrylate crosslinked compound), which is an absorbent polymer having a pendant carboxyl group as an acid group, was supplied to the water-sprayed side of the sheet of waste paper. While being supplied, the absorbent polymer was screened through a sieve having a mesh with an opening of 0.106 mm (JTS-200-45-106, Tokyo Screen Co., Ltd.) (see FIG. 19). The amount of absorbent polymer applied was 4 g.

Then the sheet of waste paper (sheet-shaped fibrous support) was folded in half to make a valley fold on the side with adhering absorbent polymer. In this folded state (A5 size), the sheet-shaped fibrous support was compressed in the thickness of direction and heated using a pair of heating blocks such as illustrated in FIG. 20. The compression was at 0.3 kg/cm², and the heating temperature was 100° C. The duration of heating and compression was 2 minutes.

Then heating and compression was stopped, and, after the sheet-shaped fibrous support returned to room temperature, the sheet-shaped fibrous support was cut into chips measuring 2 mm×15 mm. The absorbent polymer content of the chips was 50% by weight, and the average diameter of the particles of the absorbent polymer was between 35 and 50 μm. The average length of fiber threads was 25 mm, and the average width of the fibrous support was 10 mm. In each chip, the absorbent polymer had spread inside (was implanted in) the fibrous support.

### Examples 2 and 3

An ink absorbing material was produced in the same way as in Example 1 above except that chip parameters were changed as presented in Table 1.

### Example 4

### [1] Production of an Ink Absorbing Material

First, a sheet of waste paper measuring 30 cm long, 22 cm wide, and 0.5 mm thick (A4 sheet-shaped fibrous support) was prepared. The average length, average width, and aspect ratio (average length/average width) of the fiber threads contained in this sheet of waste paper were 0.71 mm, 0.2 mm, and 3.56, respectively. The weight of the waste paper was 4 g/sheet.

Then the entire surface of this sheet of waste paper was coated, by spraying from one side, with 100 g of an aqueous solution of liquid polyvinyl alcohol (95 g of water and 5 g of polyvinyl alcohol) as a water-soluble adhesive agent (see FIG. 18).

Then, SANFRESH 500MPSA (Sanyo Chemical Industries) as a crosslinked polyacrylic-acid polymer (partially sodium polyacrylate crosslinked compound), which is an absorbent polymer having a pendant carboxyl group as an acid group, was supplied to the side of the sheet of waste paper sprayed with the water-soluble adhesive agent. While being supplied, the absorbent polymer was screened through a sieve having a mesh with an opening of 0.106 mm (JTS-200-45-106, Tokyo Screen Co., Ltd.) (see FIG. 19). The amount of absorbent polymer applied was 4 g.

Then the sheet of waste paper (sheet-shaped fibrous support) was folded in half to make a valley fold on the side with adhering absorbent polymer. In this folded state (A5 size), the sheet-shaped fibrous support was compressed in the thickness of direction and heated using a pair of heating blocks such as illustrated in FIG. 20. The compression was at 0.3 kg/cm², and the heating temperature was 100° C. The duration of heating and compression was 2 minutes.

Then heating and compression was stopped, and, after the sheet-shaped fibrous support returned to room temperature, the sheet-shaped fibrous support was pulverized in a mill for 60 seconds. In Example 4, the resulting powder contained fibrils (flocs) and irregularly shaped chips. The absorbent polymer content of the chips (fiber and absorbent polymer) was 50% by weight, and the average diameter of the particles of the absorbent polymer was between 35 and 50 μm. The water-soluble adhesive agent content of the chips was 2.5% by weight of the fiber. In each chip, the absorbent polymer had spread inside (was implanted in) the fibrous support.

### Examples 5 to 7

An ink absorbing material was produced in the same way as in Example 1 above except that chip parameters were changed as presented in Table 1.

It should be noted that Examples 1 to 3 and 5 to 7 have a regular shape (rectangular), and Example 4 is in irregular shapes.

### [2] Testing

### [2-1] Absorption Properties (2 Minutes)

First, AS ONE Corporation's New Disposable Cup 100 mL plastic containers were prepared. The ink absorbing materials produced in Examples above, 2.0 g each, were put into separate containers to the bulk density presented in Table 1. The ink absorbing materials in the containers were checked, finding almost no absorbent polymer had detached.

Then 25 cc of a commercially available ink jet ink (ICBK-61, Seiko Epson Corporation) was poured into the containers with encased ink absorbing materials therein. Two minutes after all ink was poured, the inside of the containers was visually inspected. The condition was graded according to the following criteria.

A: There is no ink bleed on the surface of the ink absorbing material.

B: Ink bleeds are found on part of the surface of the ink absorbing material, but no ink pool is observed; almost all ink has been absorbed.

C: Ink bleeds are found on part of the surface of the ink absorbing material, and some ink pools are observed.

D: Ink pools are observed on the surface of the ink absorbing material.

### [2-2] Absorption Properties (5 Minutes)

First, AS ONE Corporation's New Disposable Cup 100 mL plastic containers were prepared. The ink absorbing materials produced in Examples above, 2.0 g each, were put into separate containers to the bulk density presented in Table 1.

Then 25 cc of a commercially available ink jet ink (ICBK-61, Seiko Epson Corporation) was poured into the containers with encased ink absorbing materials therein. Five minutes after all ink was poured, the inside of the containers was visually inspected. The condition was graded according to the following criteria.

A: There is no ink bleed on the surface of the ink absorbing material.

B: Ink bleeds are found on part of the surface of the ink absorbing material, but no ink pool is observed; almost all ink has been absorbed.

C: Ink bleeds are found on part of the surface of the ink absorbing material, and some ink pools are observed.

D: Ink pools are observed on the surface of the ink absorbing material.

### [2-3] Absorption Properties (30 Minutes)

First, AS ONE Corporation's New Disposable Cup 100 mL plastic containers were prepared. The ink absorbing materials produced in Examples above, 2.0 g each, were put into separate containers to the bulk density presented in Table 1.

Then 25 cc of a commercially available ink jet ink (ICBK-61, Seiko Epson Corporation) was poured into the containers with encased ink absorbing materials therein. Thirty minutes after all ink was poured, the inside of the containers was visually inspected. The condition was graded according to the following criteria.

A: There is no ink bleed on the surface of the ink absorbing material.

B: Ink bleeds are found on part of the surface of the ink absorbing material, but no ink pool is observed; almost all ink has been absorbed.

C: Ink bleeds are found on part of the surface of the ink absorbing material, and some ink pools are observed.

D: Ink pools are observed on the surface of the ink absorbing material.

TABLE 1

| | | | | | Water- | | | | |
|---|---|---|---|---|---|---|---|---|---|
| | | | | | soluble | | | | |
| | Absorbent polymer | | | | adhesive | | | | |
| | Average | | Fibrous support | | agent | | Testing | | |
| | particle | Amount | Average | Average | Percentage | Bulk | Absorption | Absorption | Absorption |
| | diameter | [% by | length | width | [% by | density | properties | properties | properties |
| | [μm] | weight] | [mm] | [mm] | weight] | [g/cm³] | (2 minutes) | (5 minutes) | (30 minutes) |
| Example | 35 to 50 | 50 | 25 | 10 | — | 0.2 | D | D | D |
| 1 | | | | | | | | | |
| Example | 35 to 50 | 50 | 25 | 5 | — | 0.2 | D | D | D |
| 2 | | | | | | | | | |
| Example | 35 to 50 | 50 | 25 | 2.5 | — | 0.2 | D | D | D |
| 3 | | | | | | | | | |
| Example | 35 to 50 | 50 | Random, ranging from | Same as | 2.5 | 0.05 | A | A | A |
| 4 | | | flocculent fibrils to | on the left | | | | | |
| | | | about 5-mm squares | | | | | | |
| Example | 35 to 50 | 50 | 25 | 2 | — | 0.07 | C | C | C |
| 5 | | | | | | | | | |
| Example | 35 to 50 | 50 | 3 | 2 | — | 0.2 | D | D | A |
| 6 | | | | | | | | | |
| Example | 35 to 50 | 50 | 15 | 2 | — | 0.08 | C | B | A |
| 7 | | | | | | | | | |

As is clear from Table 1, Examples of the present invention demonstrated superior absorption properties.

Although not presented in the table, the ink absorbing materials in Examples 1 to 7 were observed in the containers at 24 hours in the same way as in [2-1] to [2-3] with the result that there was no ink bleed on the surface of the ink absorbing material (grade A). That is, the ink absorbing materials in Examples 1 to 7 were superior in ink absorption properties and fall within the scope of application of the present invention.

Then the testing for the materials' anti-leakage effect was repeated in the same way except that Seiko Epson's ink jet ink (ICBK80) was replaced with Canon's ink jet ink (BCI-381sBK), Brother's ink jet ink (LC3111BK), and Hewlett-Packard's ink jet ink (HP 61XL CH563WA). The results were the same.

Then the testing for the materials' anti-leakage effect was further repeated in the same way except that various changes were made to the volume and shape of the container and the amount of ink supplied. The results were the same.

10 . . . chip aggregate (ink absorbing material), 1 . . . chip, 1A . . . first chip group, 1B . . . second chip group, 11 . . . bend (fold), 12 . . . folded portion, 2 . . . fibrous support, 21 . . . front surface, 22 . . . back surface, 3 . . . absorbent polymer, 4 . . . connector, 5 . . . adhesive agent (water or a water-soluble adhesive agent), 8 . . . lid, 81 . . . connection opening, 82 . . . lower surface (back surface), 9 . . . container, 91 . . . bottom (bottom plate), 92 . . . side wall, 921 . . . protrusion, 93 . . . packing space, 94 . . . upper opening, 95 . . . void, 96 . . . top surface, 97 . . . connection port, 20 . . . gap, 100 . . . ink absorbing device, 200 . . . printing apparatus, 201 . . . ink-ejecting head, 201a . . . nozzle, 202 . . . capping unit, 203 . . . tube, 203a . . . outlet (opening), 204 . . . roller pump, 204a . . . roller section, 204b . . . holding section, L₁ . . . total length (longitudinal length), Q . . . ink, t₁ . . . thickness, W₁ . . . width (transverse length), V1 . . . volume, V2 . . . total volume, 300 . . . stage, 400 . . . mesh element, 401 . . . mesh openings, 500 . . . heating block

1. An ink absorbing material comprising a chip aggregate that includes a plurality of chips each having a fiber-containing first fibrous support and an absorbent polymer that is held by the first fibrous support as a result of gluing to the first fibrous support with water or a water-soluble adhesive agent.

2. The ink absorbing material according to claim 1, wherein each of the chips have a fiber-containing second fibrous support, and the absorbent polymer is between the first fibrous support and the second fibrous support; and
the first fibrous support and the second fibrous support are joined together by the absorbent polymer and the water or water-soluble adhesive agent.

3. The ink absorbing material according to claim 2, wherein each of the chips forming the chip aggregate is a cut or pulverized piece, and the absorbent polymer is somewhere in a thickness dimension of the chips and is exposed at an end face of the chips.

4. The ink absorbing material according to claim 1, wherein each of the chips is elongated one.

5. The ink absorbing material according to claim 4, further comprising a connector that connects part of each of the elongated chips together.

6. The ink absorbing material according to claim 1, wherein the absorbent polymer contains a crosslinked polyacrylic-acid polymer.

7. An ink absorbing device comprising the ink absorbing material according to claim 1 and a container in which the ink absorbing material is encased, wherein
each of the chips is elongated, and the ink absorbing material is encased in the container in such a manner that each of the chips extends in a direction that crosses a direction in which another extends inside the container.

8. An ink absorbing device comprising the ink absorbing material according to claim 1 and a container in which the ink absorbing material is encased, wherein
each of the chips is elongated, and the ink absorbing material is encased in the container in such a manner that each of the chips extends in the same direction inside the container.

9. An ink absorbing device comprising the ink absorbing material according to claim 1 and a container in which the ink absorbing material is encased, wherein
each of the chips is elongated, and the ink absorbing material is encased in the container with the chips folded inside the container.

10. A droplet ejecting apparatus comprising the ink absorbing device according to claim 7, wherein the ink absorbing device is used to absorb waste ink.

11. An ink absorbing material comprising a chip aggregate that includes a plurality of chips each having a fiber-containing first fibrous support and an absorbent polymer at least part of which is spread inside the first fibrous support as a result of gluing to the first fibrous support with water or a water-soluble adhesive agent.

12. The ink absorbing material according to claim 11, wherein the chips has a fiber-containing second fibrous support and an absorbent polymer that is spread inside the second fibrous support as a result of gluing to the second fibrous support with water or a water-soluble adhesive agent; and
the chips are formed by the first fibrous support and the second fibrous support stacked with the absorbent polymer in the first fibrous support and the absorbent polymer in the second fibrous support touching each other.

13. The ink absorbing material according to claim 11, wherein an absorbent polymer content of the chips is 25% by weight or more and 300% by weight or less of the fiber.

14. The ink absorbing material according to claim 11, wherein the chips are in a regular shape.

15. The ink absorbing material according to claim 14, wherein the chips are strip-shaped; and
an amount of chips whose maximum width is 3 mm or less in the chip aggregate is 30% by weight or more.

16. The ink absorbing material according to claim 11, wherein the chips are in irregular shapes.

17. The ink absorbing material according to claim 11, further comprising an adhesive agent.

18. The ink absorbing material according to claim 17, wherein an adhesive agent content of the chips is 1.0% by weight or more and 70% by weight or less of the fiber.

19. The ink absorbing material according to claim 11, wherein a bulk density of the chip aggregate is 0.01 g/cm³ or more and 0.5 g/cm³ or less.

20. An ink absorbing device comprising:
the ink absorbing material according to claim 11; and
a container in which the ink absorbing material is packed.

21. A droplet ejecting apparatus comprising the ink absorbing device according to claim 20, wherein the ink absorbing device is used to absorb waste ink.

22. The ink absorbing material according to claim 12, wherein the absorbent polymers are between the first fibrous support and the second fibrous support; and
the absorbent polymers are exposed between the first fibrous support and the second fibrous support at an end face of the chips.
